(19) United States
(12) Patent Application Publication
(10) Pub. No.: US 2006/0230137 A1
(43) Pub. Date: Oct. 12, 2006

(54) Location or Activity Monitor

(76) Inventors: Christopher Gare, Farnborough (GB); Steven Gare, Farnborough (GB); Timothy Ellis, Camberley (GB)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/279,389

(22) Filed: Apr. 11, 2006

(30) Foreign Application Priority Data
Apr. 12, 2005 (GB) GB0507381.2

(51) Int. Cl. G06F 15/173

(52) U.S. Cl. 709/224; 709/225

(57) ABSTRACT

A Location or Activity or Presence Monitor enables a Providing Member to supply visibility in real-time to Requesting Members of their current location or activity, a literal or abstract description of their current location, the communications services available to them at their current location, and their willingness and ability to communicate. The presented Location or Activity information may be personalised depending upon a Member Group assigned by the Providing Member to the Requesting Member. Requesting Members who submit an enquiry for current Location or Activity information relating to a particular Providing Member will see the personalised Location or Activity information for the Providing Member's current location.

The present invention generally relates to the field of public Internet services, Wi-Fi services, private intranet services, fixed and mobile telephone services or enterprise software applications that involve communities of consumer or business users. One embodiment provides a method which enables a Providing Member to provide location, activity and “presence” related information to Requesting Members in real-time.

The ever-increasing number of ways for an individual to communicate and interact means that we all now live in an always-available, always-connected world that can invade all aspects of our daily lives. We are able to communicate and interact with our friends and work colleagues at any time of the day or night through a rich selection of fixed, wireless and web-based services. The direct personal and business benefits of this ease of communication are easy to appreciate as we all experience them every day of our lives.

One consequence of the wide-spread use of telecommunications services is that we have seen fundamental changes take place in our work and social activities. If you look at what activities the majority of employees undertake today during their work hours, it would centre on sitting in front of their PC and making and taking calls on a fixed desk telephone or mobile phone. These activities could be easily undertaken in locations other than the base office, such as at home at much lower cost for the employer and with a much improved lifestyle for the employee. Another common method of reducing the commuting slog to the base office by employees is the use of what are known as “hot desks” in a local office nearer to your home than the base office. Hot desks are typically shared by several employees and are equipped with shared Internet access and a shared desk telephone.

Additionally, many of us now work in multiple locations that include not only the base, local and home offices described above but also hotels we are visiting, friend's houses, Internet cafes, cars, trains, airports or Wi-Fi hot spots. The direct consequence of this is that we need to make the multiplicity of physical locations we use as transparent as possible to other parties that we need to communicate with while providing sufficient information to allow them to communicate with us in the most optimal and convenient way. If this is not achieved, work colleagues might think you are physically in the base office when, in reality, you are not. As a consequence, work colleagues may be rushing around the office trying to physically locate you without success or wondering where you are.

At each location we use for work or leisure we may have a different set of available communications services such as fixed telephones, mobile telephones, VoIP services, instant messaging services, faxes or pagers. These will all have different telephone numbers or, in the case of VoIP and instant messaging services, different aliases for business and home use. Even then, you may not wish to use an available service in a particular location or undertaking a particular activity. There is therefore a need to be able to tell colleagues and friends not only where you are located or what your current activity is but also what communication facilities are available to you at that particular time. Moreover, even though you have particular communication services available, you may still wish to be unavailable as you are undertaking a particular activity where you do not wish to be interrupted.

In addition to Location or Activity, the available services which you wish to use at that Location or Activity and your availability wishes, there is another important aspect that individuals need to consider in this always-available world. This is concerned with managing who we communicate with and when. We all have different ‘communities’, ‘groups’ or ‘categories’ of people we need to communicate with, which can broadly be split into personal and work camps. In the personal camp can be your partner, girlfriend, boyfriend, family, networked community members and friends etc. In the work camp is your manager, co-workers, project team members, peers, subordinates, customers, suppliers, associates, board members, shareholders, and management peers etc.

To manage and balance our work and personal lives more effectively there is a need to provide guidance and provide better control over when different people can communicate with us when we are at particular Locations carrying out particular Activities For example, you may be formally working at home on certain days of the week and are quite happy to respond to communications of a work nature. When not working however, you might not want to take work related calls at home. The present invention addresses these and other needs by providing, in one aspect, a method of providing current Location or Activity information for a first individual to a second individual comprising the steps of: storing regular or routine or temporary schedule Location or Activity information relating to a plurality of Locations or Activities of the first individual, each Location or Activity being associated with a time period for which the respective Location or Activity is an active Location or Activity; receiving, at a time, a request from the second individual for Location or Activity information for the first individual; and providing to the second individual Location or Activity information for the first individual for the Location or Activity that is the active Location or Activity at the time of the request. Each Location or Activity has a chosen (or pre-defined) Location or Activity description which may or may not be informative of the real physical Location or Activity. Requesting individuals are therefore able to see, in real-time, Location or Activity information for a providing individual, which may include a description of their Location or Activity, the country they are currently located in, their local time or time zone, their willingness to communicate, as well as contact information or available communication services such as fixed telephone numbers, mobile telephone numbers, voice over IP telephony services, email addresses, physical addresses, instant messaging addresses, telephone or video conferencing services, details of a Wi-Fi hotspot, personal assistants or alternative contacts if you are on holiday or away on a business trip.

Preferably, the Location or Activity information further includes numbers, network addresses, URLs or user aliases for network locations that describe communication or interaction services available to the providing individual at their active Location or Activity. This may be particularly useful for network communication services such as instant messaging or VoIP where a requesting individual may need to learn which services a providing individual uses before they can contact the providing individual.

Preferably, the Location or Activity information includes a default Location or Activity used as an active Location or Activity at a time when no other Location or Activity is an active Location or Activity. In this way, a providing individual need not set up a location that will be active for every minute of the day since a default location will be displayed if there is no other active Location or Activity.

Preferably, the first individual is a user of a service for providing Location or Activity information and the method further comprises sending an invitation from the first individual to the second individual inviting the second individual to become a member of the service. The method may further include the step of the second individual receiving the invitation from the first individual and accepting or declining the invitation. In this way, membership of the service can be quickly expanded. If the service provider charges a subscription, this will rapidly increase the amount of revenue earned by the service provider.

Preferably, the method further comprises the first individual pre-authorising the second individual to see the current or active Location or Activity of the plurality of Locations or Activities of the first individual. The providing individual can therefore decide in advance which requesting individuals will have access to their Location or Activity information such that, when a requesting individual makes a request, no further authorisation is required.

Preferably, the Location or Activity information includes default Location or Activity information that is provided to a second individual if the second individual is not authorised to see the location information for the active Location or Activity. In this way, a requesting individual will always receive some Location or Activity information, which may simply be a brief message of apology, even if they are not authorised to see the active Location or Activity information.

Preferably, the method further comprises the steps of: the first individual assigning the second individual to one of a plurality of categories; and the first individual associating the one category of the plurality of categories with a Location or Activity such that the second individual that is assigned to that category is pre-authorised to see the Location or Activity information for the associated Location or Activity. In this way, a providing individual may authorise requesting individuals by category, rather than having to specifically authorise them one at a time.

Preferably, the method further comprises the first individual previewing their Location or Activity information that would be provided to the second individual. This useful feature allows a providing individual to check what Location or Activity information a particular requesting individual would see at a selected time or day.

Preferably, the method further comprises: assigning a transparent priority level to each Location or Activity; and if more than one Location or Activity is an active Location or Activity providing to the second individual Location or Activity information for the active Location or Activity that has the highest priority. In this way, a providing individual can have Locations or Activities that overlap each other in time, and only the Location or Activity information with the highest priority will be provided to requesting individuals.

Preferably, the Location or Activity information is extracted from an electronic calendar of the first individual to simplify the process of storing the Location or Activity information. In other embodiments, the first individual enters (or supplements automatically retrieved) Location or Activity information using a calendar-like interface provided as a component of the service. Location or Activity information may also be obtained automatically by retrieving account status information of the first individual from an Internet VoIP, instant messaging or other service provider. In other embodiments, Location or Activity information may be pushed synchronously to multiple Internet communication service providers using a variety of methods including SMS messages.

Preferably, the Location or Activity information further comprises an override Location or Activity (“QuickStatus”) and the method further comprises the first individual setting the override Location or Activity as the currently active Location or Activity. In this way, a providing individual may quickly change their Location or Activity by using a personal computer, PDA or mobile telephone if they will be temporarily unavailable at their supposed current or active Location or Activity.

Another aspect of the present invention provides an apparatus for providing Location or Activity information for an individual to a client device comprising: a database for storing Location or Activity information relating to a plurality of Locations or Activities of the first individual, each Location or Activity being associated with a time period for which the respective Location or Activity is an active Location or Activity; and a processor in communication with the database, the processor being programmed to: receive, at a time, a request from the client device for Location or Activity information for the first individual; retrieve, from the database, Location or Activity information for the first individual for the Location or Activity that is the current or active Location or Activity at the time of the request; and send the retrieved Location or Activity information to the client device.

Preferably, the processor is connected to a network, more preferably a public network such as the Internet, although embodiments of the invention may also operate on a private network such as an intranet, LAN or WAN. The client device can then communicate with the processor, which may be a server computer for example, over the network.

The client device itself may be any of a personal computer, a personal digital assistant, a mobile telephone, a games console, a network or IP-enabled fixed line telephone, or a network-enabled home entertainment system.

Preferably the processor is programmed to send the retrieved Location or Activity information to the client device formatted as at least one web page. In this way, no special software is required by the client device since most client devices will have web-browser software which is able to interpret a web page.

Preferably, the processor is further programmed to receive, from a client device of the individual, Location or Activity information for storing in the database. In this way, a providing individual can update the database with Location or Activity information using any suitable client device.

In another aspect, the present invention provides a method of retrieving Location or Activity related information about a first user by a second user comprising the steps of: receiving from the second user identification information identifying the first user; determining a current country and local time for the first user; retrieving from a database details of a Location or Activity and displaying the retrieved details to the second user “in their local time” including contact information for the first user for the current local time; and displaying the retrieved details to the second user.

In some embodiments, the present invention provides methods, user interfaces, methodologies, processes, architectures and systems whereby a providing individual is able to supply visibility in real-time of their current Location or Activity, their willingness or ability to communicate, the services they are able or willing to use at their current location and to personalise the presented information depending on a defined Member Group assigned to a Requesting Member by the Providing Member.

Embodiments of the present invention enable any individual to improve communications with colleagues and friends by providing real time guidance as to how they can communicate or interact with you at their present Location or Activity, thereby reducing frustration and stress on the part of any individual that needs to communicate with them.

In one embodiment, the present invention may be run as a stand-alone public on-line Internet service or as private standalone enterprise intranet service or enterprise software application. In a second embodiment, the present invention may be used as a “bolt-on” additional revenue-enhancing capability to an existing third party on-line community orientated Internet service, enterprise intranet service or enterprise software application. These third party services or software applications could be: (a) address book or contact synchronisation services; (b) business, personal, or social networking communities; (c) conferencing centre services; (d) personal identity management services; (e) instant messaging services; (f) chat or dating communities; (g) gaming or gambling communities; (h) calendar related services; or (g) mobile or fixed telephone operators.

Examples of existing services that would benefit from the “bolting on” of the present invention are: (a) identity, address book or contact list synchronisation services such as Plaxo™, GoodContacts™, Corex™, Midentity™, BT Contact™, CRM oriented services such as Salesforce.com™ and enterprise calendaring software applications; (b) business, personal, or social networking communities that enable consumer and business individuals to network together and share contacts on-line such as LinkedIn™, ZeroDegrees™, Ryze™, eCademy™, Friendster™, Orkut™ and FriendsReunited™; (c) conferencing centre services such as WebEx™, IBM Lotus and Sametime™; (d) instant messaging services such as MSN™, AOL AIM™, Yahoo Messenger™, ICQ™, Skype™ Messaging and IBM Lotus Sametime™; or (e) Blackberry™ or other remote email services.

Embodiments of the present invention enable a Providing Member to define a set of permanent and/or temporary Locations or Activities that they can use to describe their current location e.g. “I'm working at home”, “I'm in the office”, “I'm at a Wi-Fi hot spot”, or “I'm in Hong Kong”. They can also be activities such as “I'm sleeping”, “I'm currently abroad in Hong Kong”, or “I'm in a meeting”.

Embodiments of the present invention enable a Providing Member to pro-actively choose how literal or abstract a description of a Location or Activity is depending on their own preferences e.g. one Providing Member could choose to create a Location or Activity described as “I'm sleeping” while another would only be comfortable with a Location or Activity described as “I'm not available”.

Embodiments of the present invention enable a Providing Member to assign a “QuickStatus” button to selected Locations or Activities that can be set from a Console running on a PC, PDA, smartphone or mobile phone that will remain for a selected period of time or until cancelled by the Providing Member.

Embodiments of the present invention enable a Providing Member to supply in real-time their current Location or Activity information to other authorized Requesting Members that wish to view it.

Embodiments of the present invention enable a Providing Member to decide whether any other authorized Requesting Members can see their current location information or not. For example, a Providing Member might like to show work orientated location or activities to work-oriented Member Groups but not personal-oriented location or activities.

Embodiments of the present invention enable a Providing Member to automatically supply in real-time their current Location or Activity to any other Requesting Member without the need to authorize each individual in advance on an “open visibility” basis to all Requesting Members whether they are authorized or not.

Embodiments of the present invention enable a Providing Member to create default availability and non-availability guidance associated with their current Location or Activity that can be seen by Requesting Members.

Embodiments of the present invention enable a Providing Member to set particular Locations or Activities as occurring on the same day every week.

Embodiments of the present invention enable a Providing Member to set particular Location or Activities as lasting for only a defined time period.

Embodiments of the present invention enable a Providing Member's supplied fixed and mobile telephone numbers or other contact methods to be automatically translated and presented in the correct form for dialling in which ever country their Requesting Members are currently located in, even if they are in that country temporarily. If the Requesting Member and the Providing Member are in the same country, only national dialling codes with be presented. If the Requesting Member and the Providing Member are in different countries, the international dialling code and the appropriate country code will be presented and the national dialling code will be suppressed. This Requesting Member orientation is not available in static enterprise software or web-based address books service where numbers are presented in the format entered by the user.

Embodiments of the present invention enable a Providing Member to identify Locations or Activities as temporary Locations or Activities by assigning a Start Date and End Date. Temporary Locations or Activities can be enabled and disabled to simplify multiple use.

Embodiments of the present invention enable a Location or Activity to have a time span associated with it such that it is possible for a Location or Activity to be considered to be an “event”. For example, it would be possible for a race course to announce their entire racing schedule throughout the race day to Requesting Members. If the Providing Member has selected public status, all Requesting Members would be able to see this schedule. Another example is for a university, college or school to use the present invention to announce lesson schedules to students. This would be especially useful for announcing any schedule slippages in real time to Requesting Members. It would be possible to “push” the updates to Requesting Members via email, SMS or by other mechanism if required.

Embodiments of the present invention enable a Providing Member to specify any number of alternative contacts such as personal assistants, secretaries, work team member, or delegated managers as an available service at a work-oriented location. Further, it is possible to supply their names, fixed and mobile telephone numbers and emails of those alternative contacts, personal assistants, secretaries or delegated managers. Personal assistants, secretaries or delegated managers do not have to be users of the service to be named as such.

Embodiments of the present invention enable a Providing Member to link fixed-line telephones and/or any number of mobile telephones to previously defined Locations or Activities and supply the country codes and telephone numbers to Requesting Members.

Embodiments of the present invention enable a Providing Member to assign Internet VoIP or instant messaging services to previously defined locations and supply the appropriate “identity aliases” if appropriate in use by the Providing Member at a current or active Location or Activity.

Embodiments of the present invention enable a Providing Member to search a database of existing Internet Communications Service Providers such as VoIP, IM or Conferencing Services and select the one they wish to use. A Providing Member can click on a hyperlink to a “Knowledge Base” where they will be able to find out more details of the service such as a hyperlink to the Service Provider's home page.

Embodiments of the present invention enable a Providing Member to link multiple personal and work email addresses with predefined location or activities.

Embodiments of the present invention enable a Providing Member to assign multiple Instant Messaging services to previously defined location or activities and supply the appropriate “identity aliases”.

Embodiments of the present invention enable a Providing Member to assign services such fax, pagers, TELEX, audio and visual conferencing services, virtual reality Internet sites, chat rooms, “meet-me” sites or any other available service to previously defined locations and supply the appropriate contact numbers.

Embodiments of the present invention enable a Providing Member to define any number of Member Groups using an appropriate text description that can be grouped into types such as ‘Friends’, ‘Work Colleagues’ or ‘Other’.

Embodiments of the present invention enable a Providing Member to supply default non-availability guidance messages that a Requesting Member would see if they were not allowed to see a Providing Member's Location or Activity because the Providing Member has created a rule that they do not wish to communicate with that particular Member Group at that Location or Activity.

Embodiments of the present invention enable a Providing Member to assign a predefined Member Group to each authorized Requesting Member that is authorized to see their location.

Embodiments of the present invention enable a Providing Member to block or delete a Requesting Member and prevent them from seeing their Location or Activity and availability information. This might be because a Requesting Member has abused a Providing Member's communications guidance such as repeatedly calling them on their mobile number in spite of indicating they do not want to receive mobile telephone calls.

Embodiments of the present invention enable a Providing Member to allow or disallow certain Member Groups from seeing particular Location or Activity information.

Embodiments of the present invention enable a Providing Member to present in an integrated form, to other Requesting Members, with or without authorization, their current Location or Activity, their willingness to communicate, the communications services available at that particular location, but to only provide that information to the Member Groups that they wish to see it at that particular Location or Activity.

Embodiments of the present invention enable a Providing Member to present the real-time integrated information to selected Member Groups in the form of a small “Pop-up” window known as a “Console” on a personal computer, Internet-enabled PDA, Internet-enabled smartphone or Internet or WAP enabled mobile telephone following a request from an another Requesting Member to see the information.

Embodiments of the present invention enable a Providing Member to preview the Location or Activity and service availability information that is currently being shown to a particular Requesting Member at a particular time and date by clicking a preview button on the Console on a personal computer, Internet-enabled PDA or Internet-enabled mobile telephone. Before previewing the published information, the Providing Member needs to select an appropriate Requesting Member that would see the information.

Embodiments of the present invention enable a Requesting Member to find out the real-time Location or Activity of a number of Providing Members at the same time with the single click of an update button on the Console. For example, this would be useful for a personal assistant who wished to find out the location and availability of a number of delinquent participants in a conference bridge. A further example, would be if a Requesting Member is participating in an on-line gaming session, they can find out the location of delinquent players for an on-line game.

Embodiments of the present invention enable a Requesting Member to automatically dial (known as “click-to-dial”) a fixed or mobile telephone number that a Providing Member has supplied when using a PDA, smartphone or mobile telephone Console.

Embodiments of the present invention enable a Requesting Member on a PC to be able to click on a VoIP or Instant Messaging (IM) Alias, open up a secondary window, hyperlink to the Service Provider's home page and initiate a VoIP call or an Instant Messaging session if the Requesting Member has a Service Provider account.

Embodiments of the present invention may automatically display the live status information of any broadband service the Providing Member is using such as VoIP, Instant Messaging or conferencing service on the Requesting Member's Console.

Further, embodiments of the present invention enable a Providing Member to update with a single click from the Providing Member's Console all the live status flags of any broadband service the Providing Member is currently using such as VoIP, Instant Messaging or conferencing service.

Embodiments of the present invention may obtain an activity update from the Providing Member's PC-based calendar. A Providing Member will often use a client calendar application to define an agenda of daily commitments. This feature means that Providing Members do not need to enter information twice since the Location or Activity database may be automatically populated by reading the electronic calendar.

Embodiments of the present invention are able to email or SMS Requesting Members in particular Member Groups when ever a Location or Activity or availability changes.

It will be clear to a skilled person that the present invention may be embodied in any suitable combination of the above aspects and preferred features.

Optionally, the method may further comprise the steps of calculating the local time where the first individual is located using the Location or Activity information; and providing the calculated local time to the second individual. This enables a Providing Member to show Requesting Members the local time of their current Location or Activity depending in which country, time zone combination they are currently located in. This is especially useful when they are travelling and they can use this to help prevent friends, family and work colleagues from calling at inappropriate times such as when they are sleeping.

Optionally, the information provided to the second individual may be a telephone number for the first individual and the method further comprises the step of reformatting the telephone number so that it may be dialled from a telephone situated in the location of the second individual. This enables a Providing Member's supplied fixed and mobile telephone numbers to be automatically translated and presented in the correct form for dialling in which ever country their Requesting Members are currently located in, even if they are in that country temporarily.

Advantageously, the reformatting step includes the addition or deletion of area or country codes. If the Requesting Member and the Providing Member are in the same country, only national dialling codes will be presented. If the Requesting Member and the Providing Member are in different countries, the international dialling code and the appropriate country code will be presented and the national dialling code will be suppressed. This Requesting member orientation is a capability not available in static enterprise software or web-based address book applications who only present numbers in the format as entered by the user.

According to a further aspect of the present invention there is provided a method of providing location information for a first individual to a second individual comprising the steps of: storing location information relating to a plurality of locations of the first individual, each location being associated with a time period for which the respective location is an active location; receiving, at a time, a request from the second individual for the local time of the first individual; calculating the local time for the first individual based on the location information; and providing to the second individual the local time of the first individual.

A preferred embodiment of the present invention will now be described by way of an example and with reference to the accompanying drawings, in which:

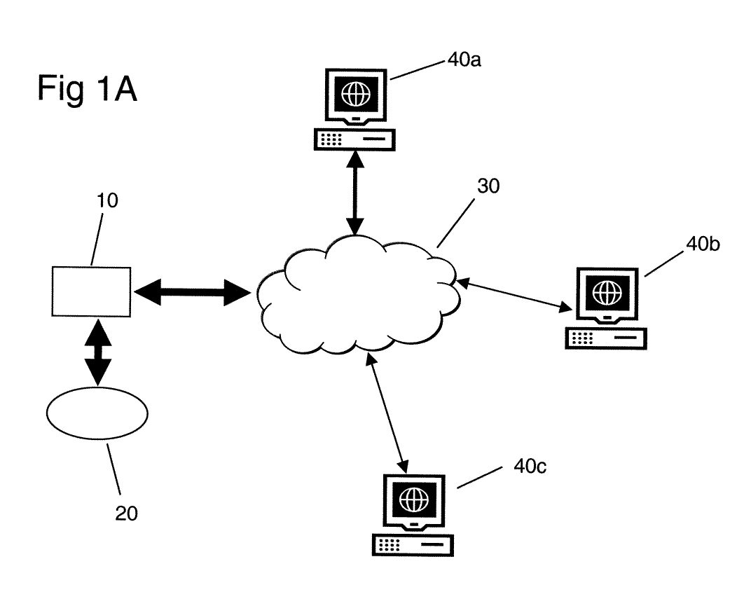

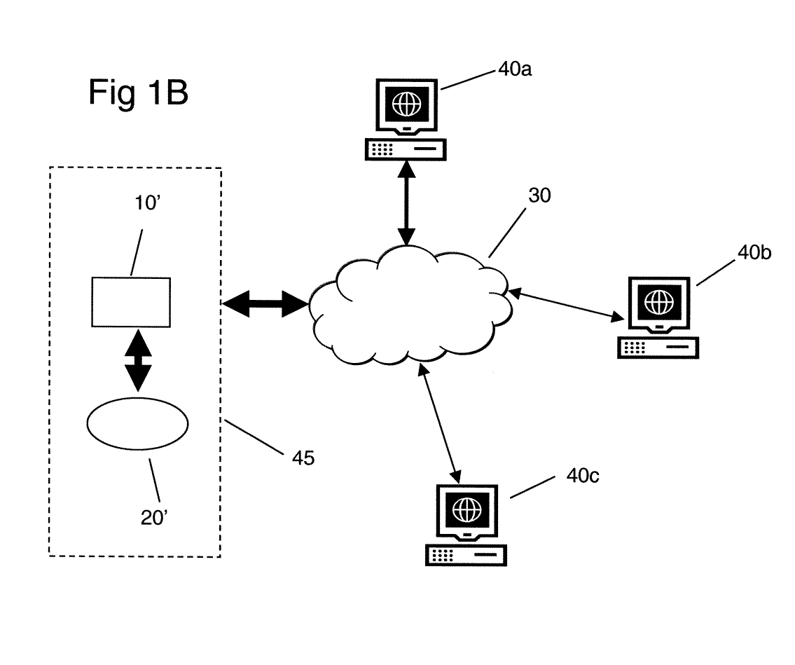

FIG. 1A illustrates an embodiment of the present invention as an on-line Internet service run on a public or private stand-alone basis;

FIG. 1B illustrates an embodiment of the present invention as a public or private ‘bolt-on’ capability to an existing Internet on-line service or enterprise software application;

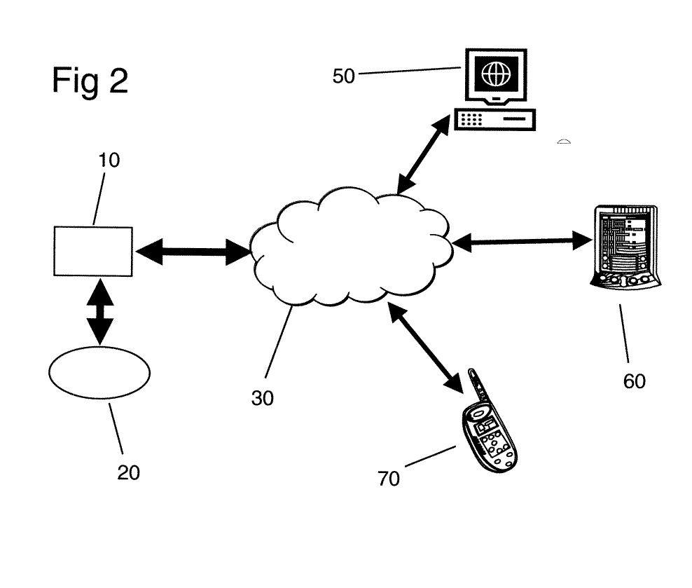

FIG. 2 illustrates an embodiment of the present invention from the perspective of the client devices that are supported;

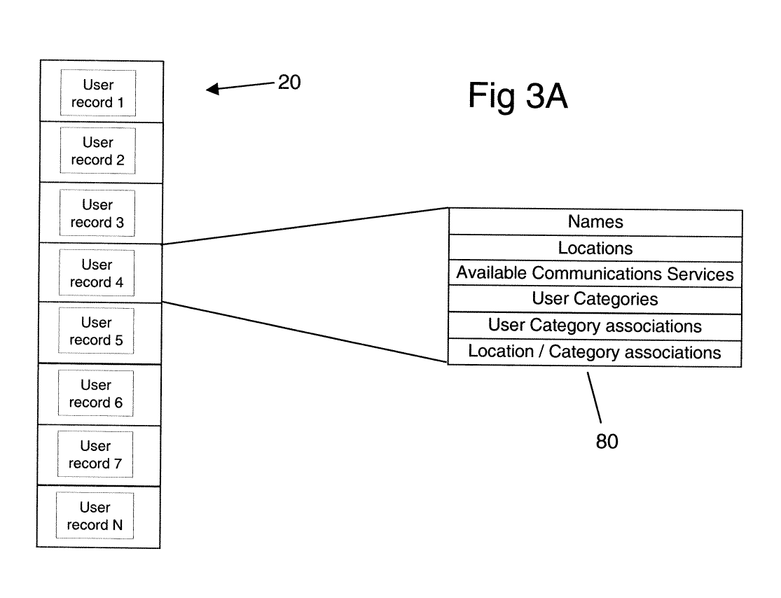

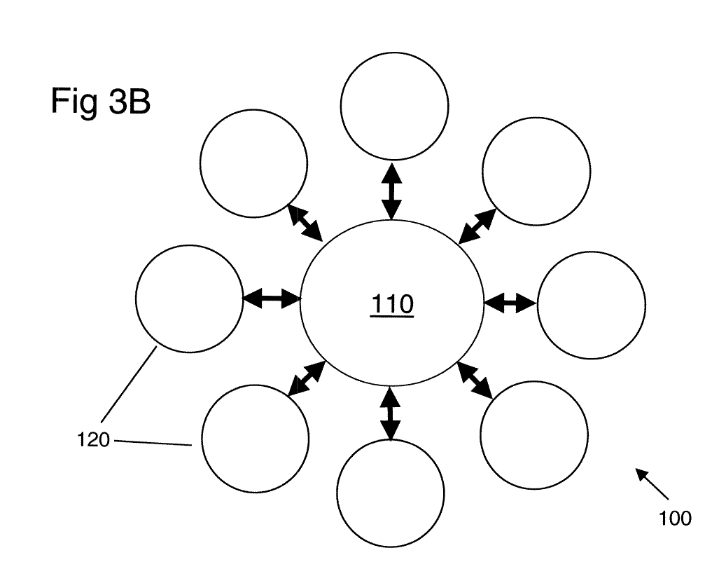

FIG. 3A illustrates a global user relational database;

FIG. 3B illustrates a Providing Member's Member Groups;

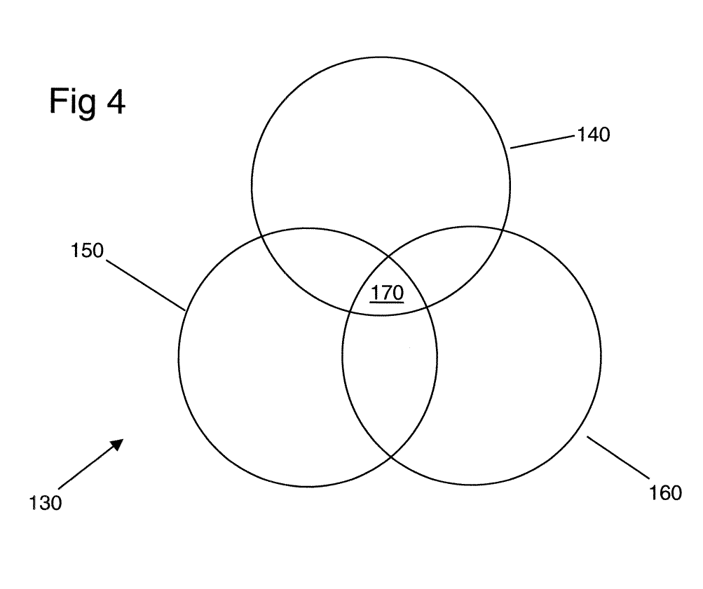

FIG. 4 is a Venn diagram of a Conditional Visibility Rule Engine (CVRE);

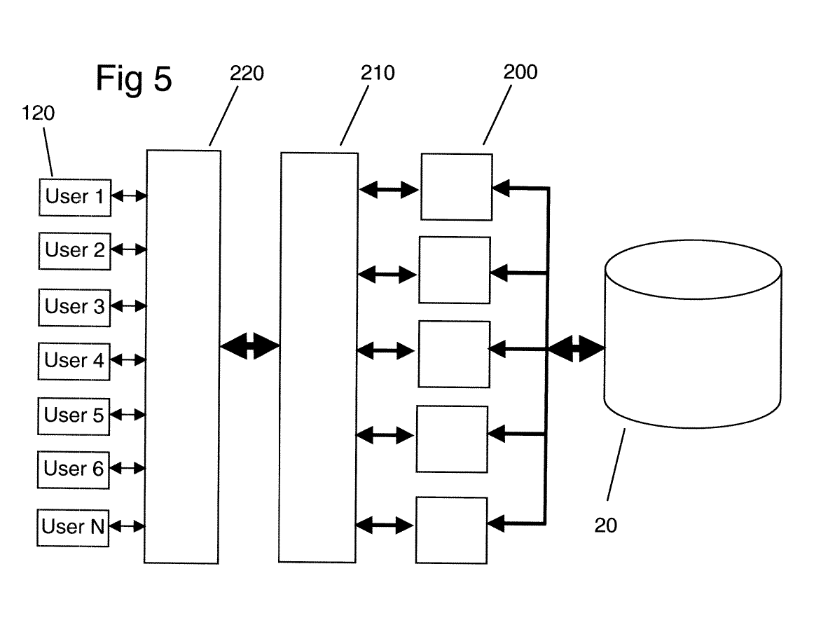

FIG. 5 illustrates an architectural block diagram of an embodiment of the present invention;

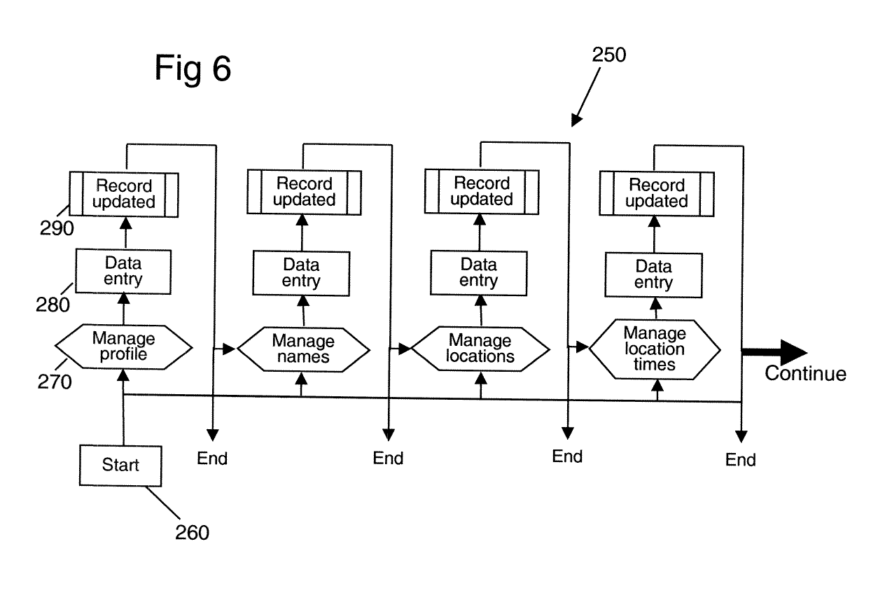

FIG. 6 illustrates part of a Providing Member Profile data entry process;

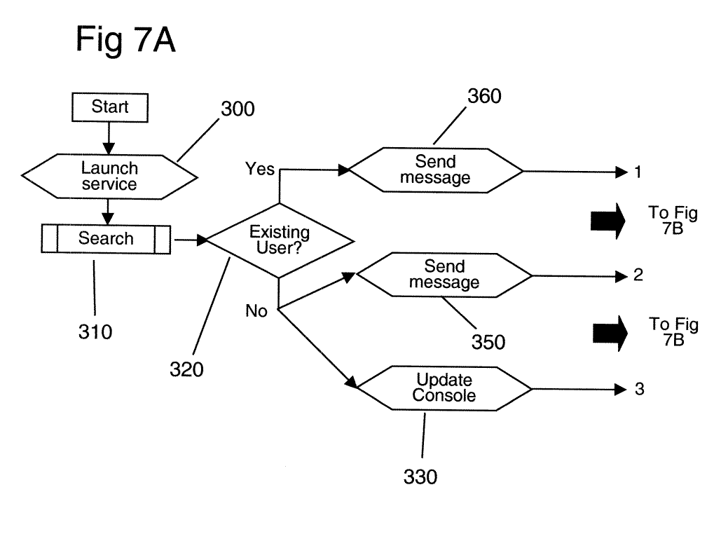

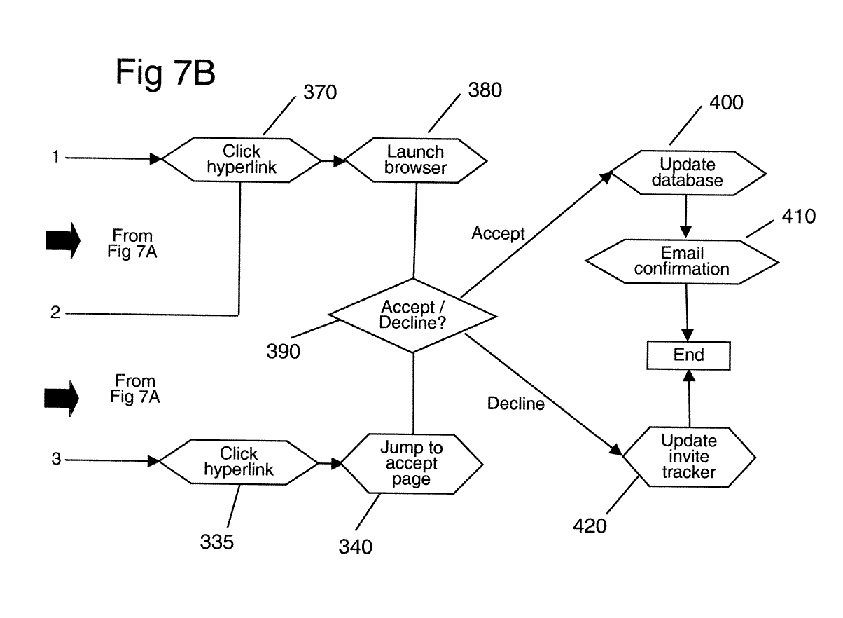

FIGS. 7A and 7B illustrate a Providing Member's Requesting Member invitation process;

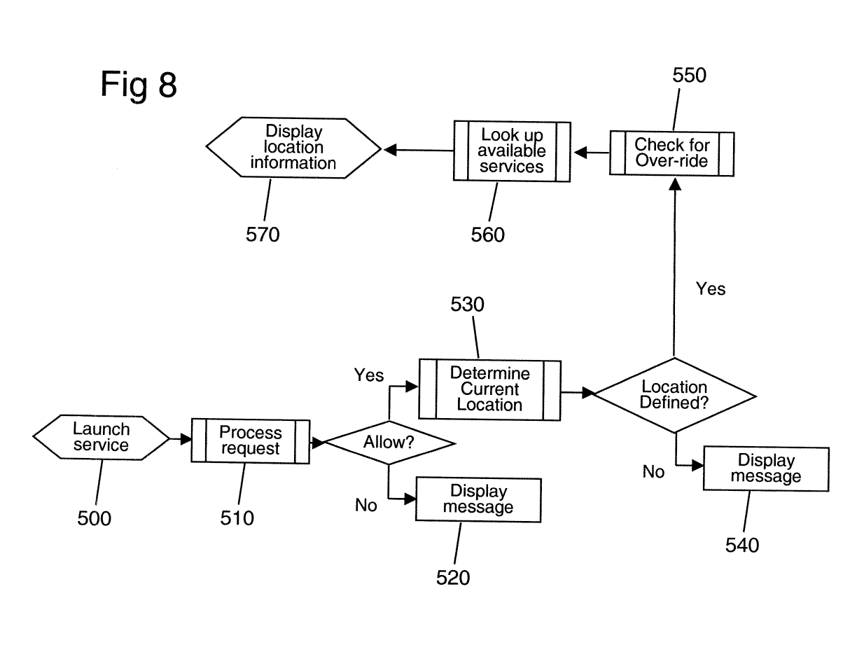

FIG. 8 illustrates a simplified Requesting Member availability request and Conditional Visibility Engine Process;

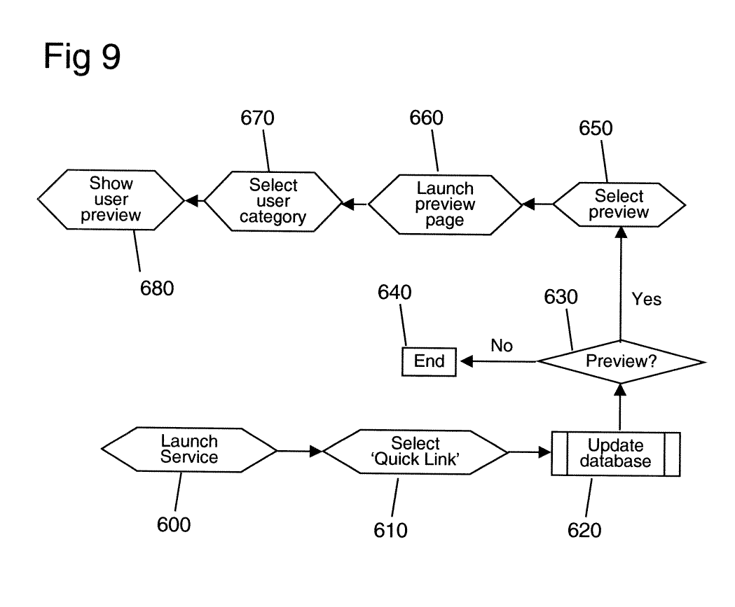

FIG. 9 illustrates a simplified set QuickStatus Location or Activity and preview status process;

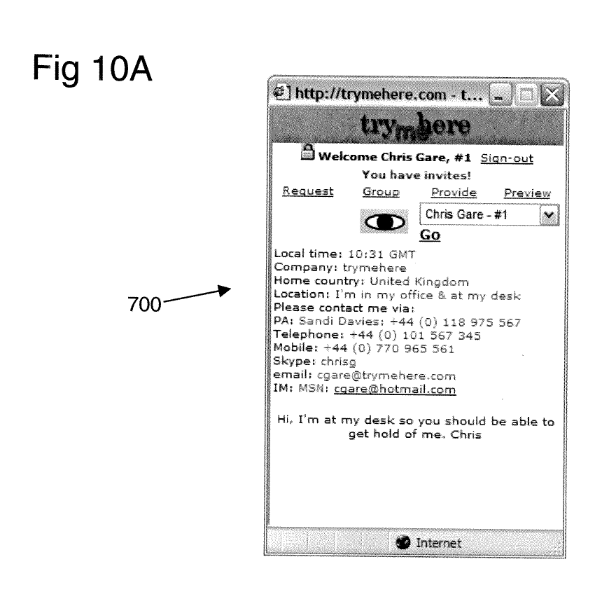

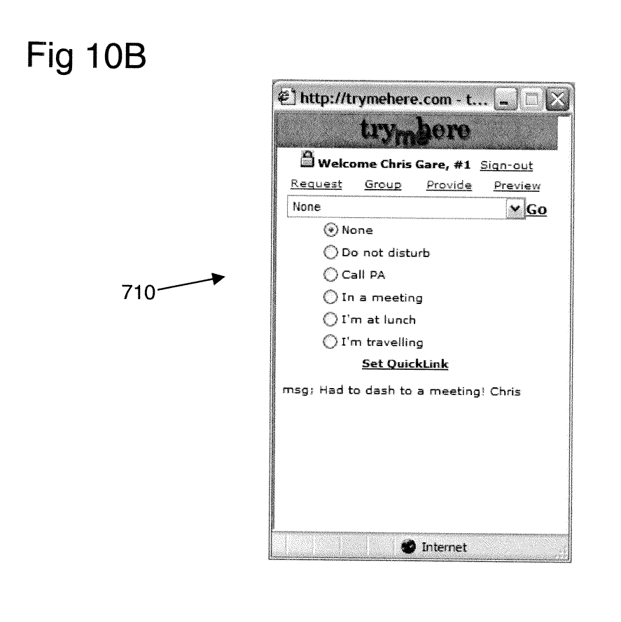

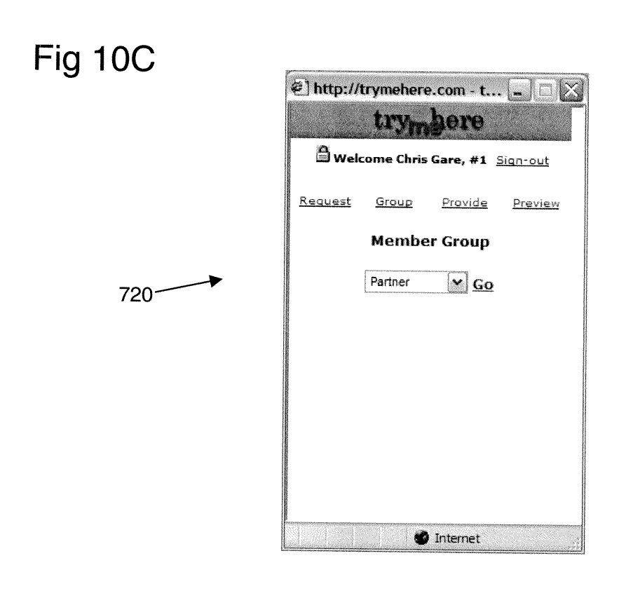

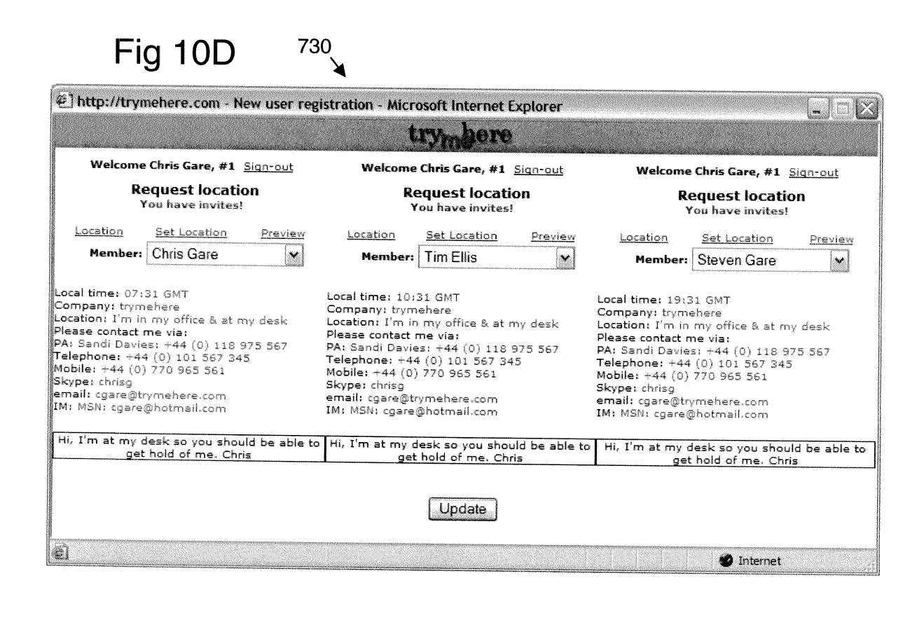

FIG. 10A shows a Requesting Member Console page;

FIG. 10B shows a Providing Member set QuickStatus Location or Activity Console page;

FIG. 10C shows a Providing Member preview Console page;

FIG. 10D shows a Requesting Member group Console page;

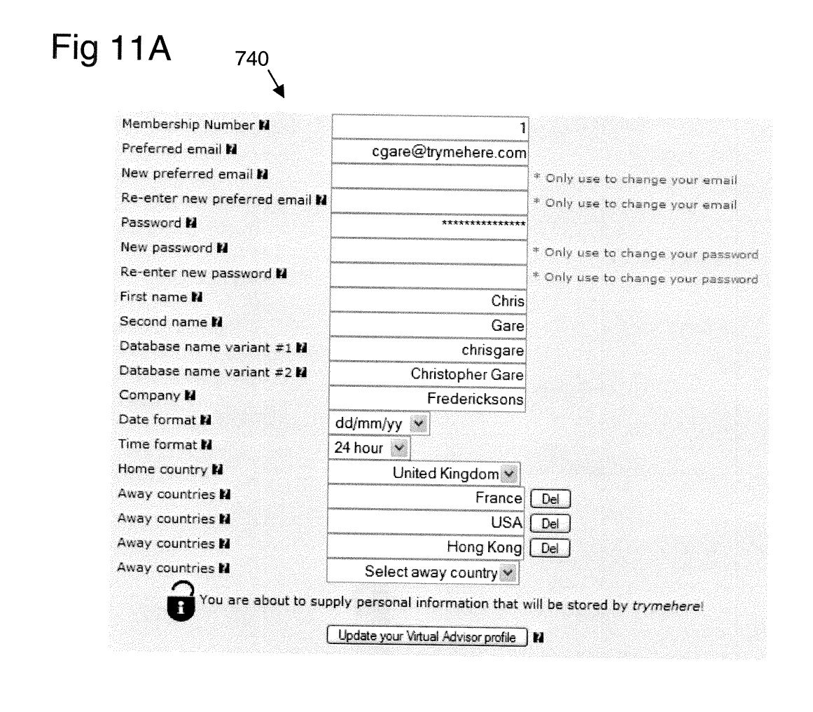

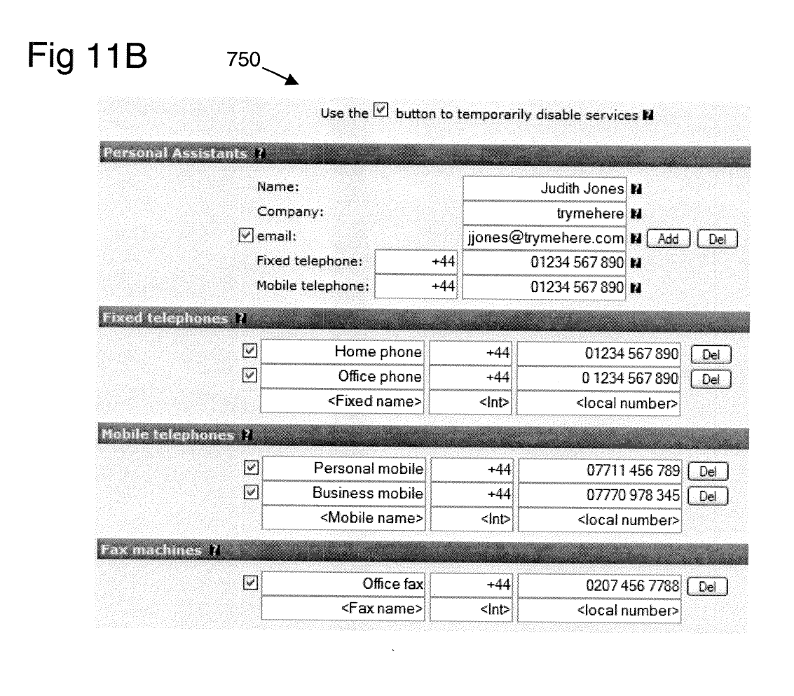

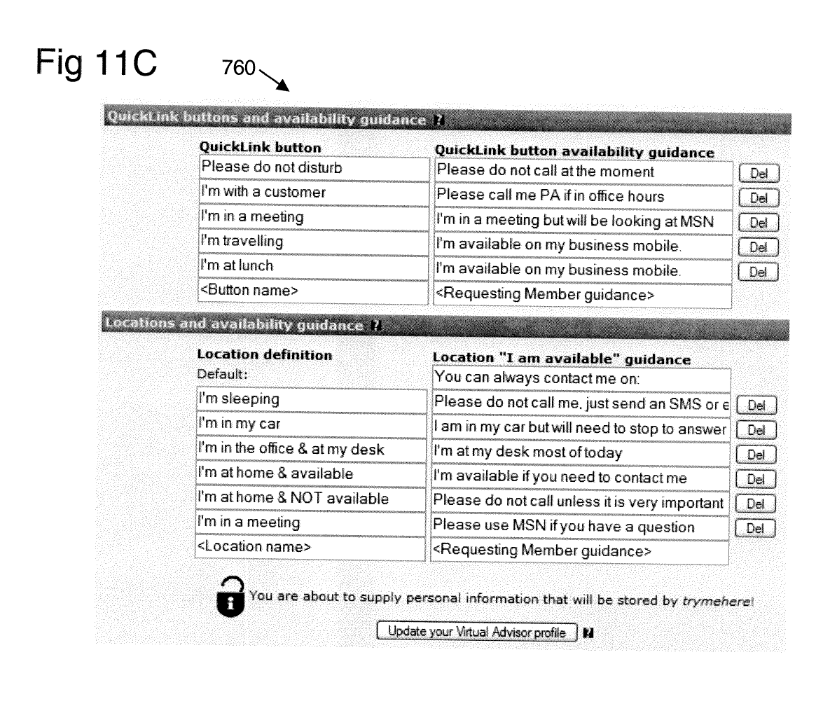

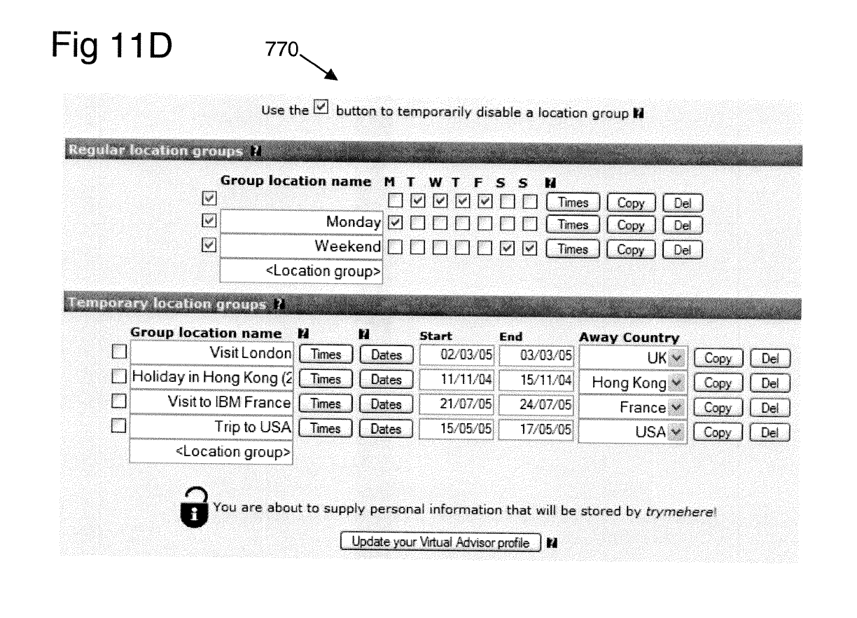

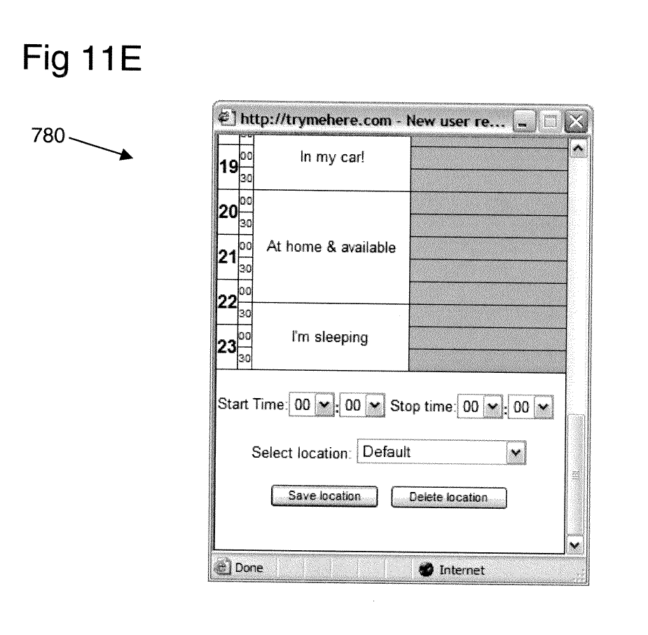

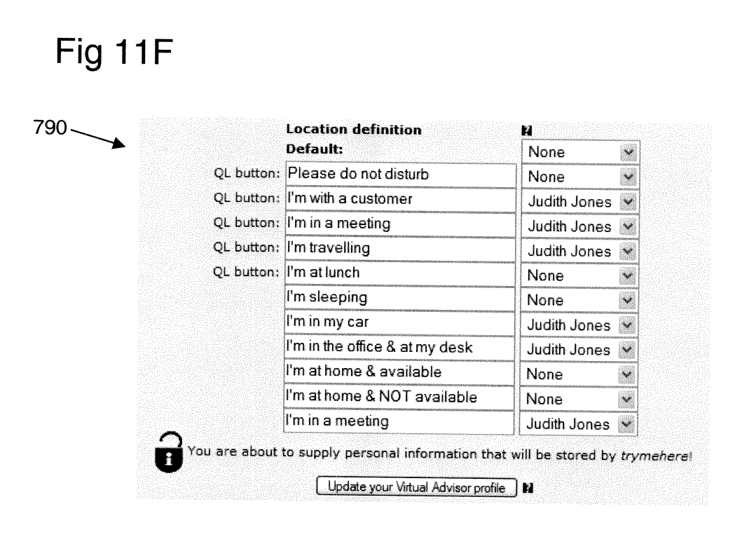

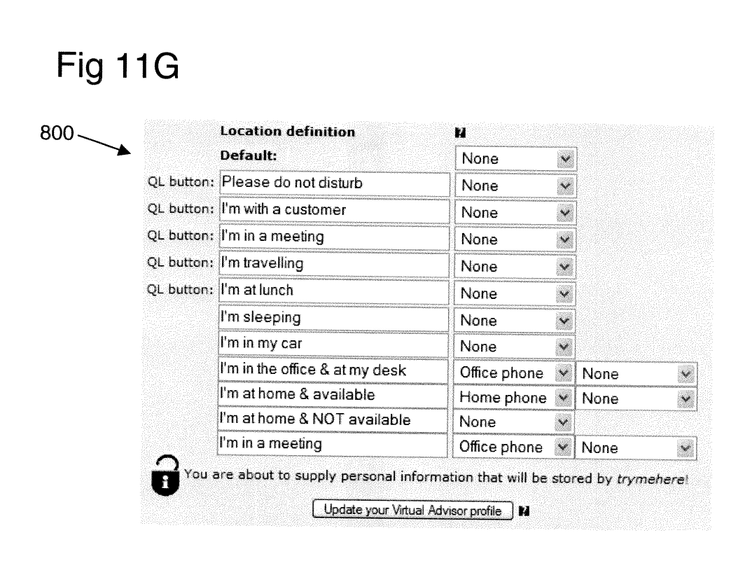

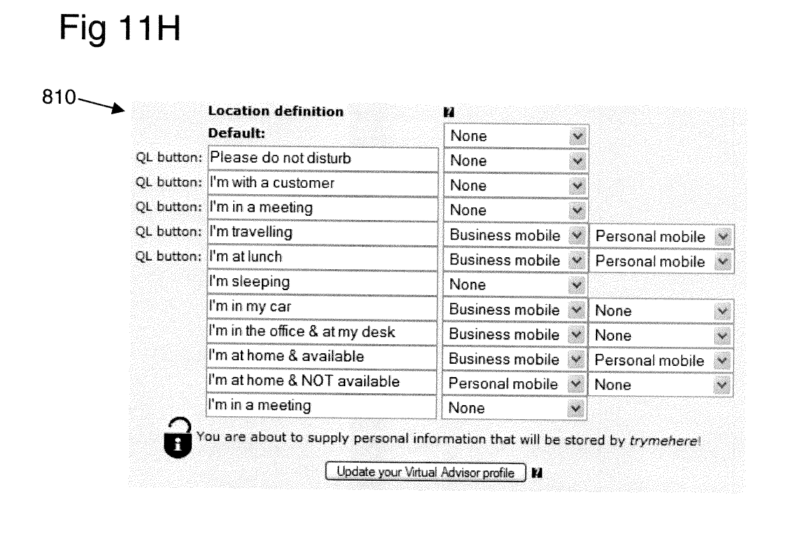

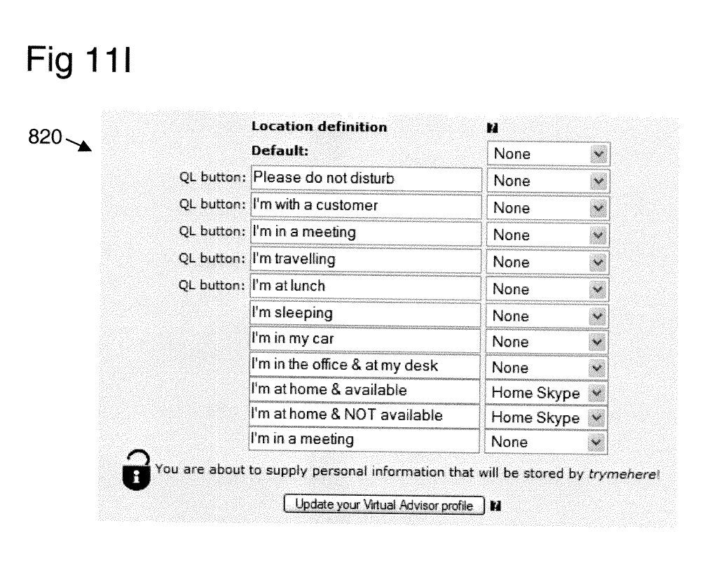

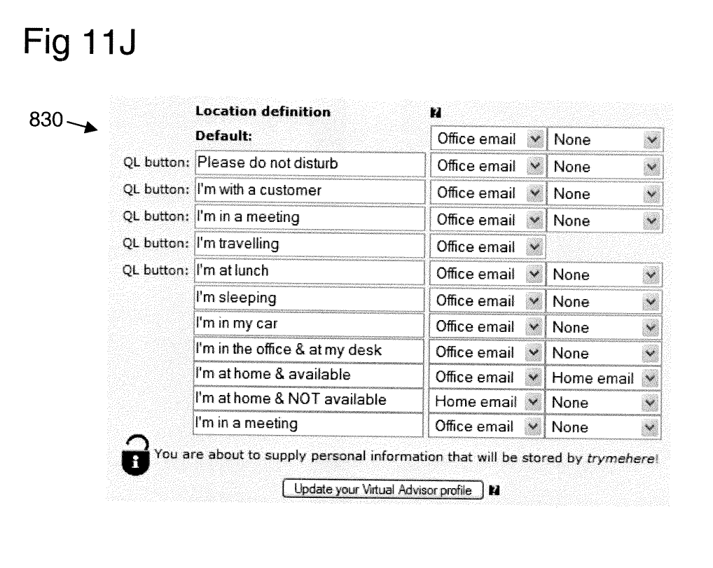

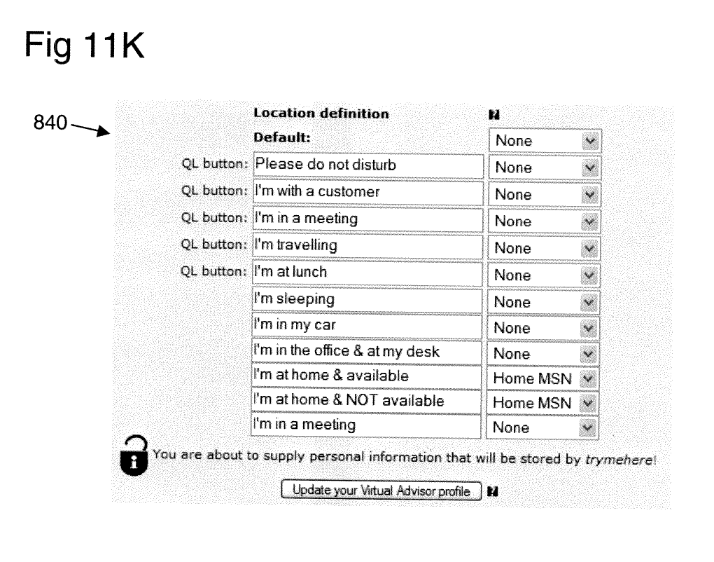

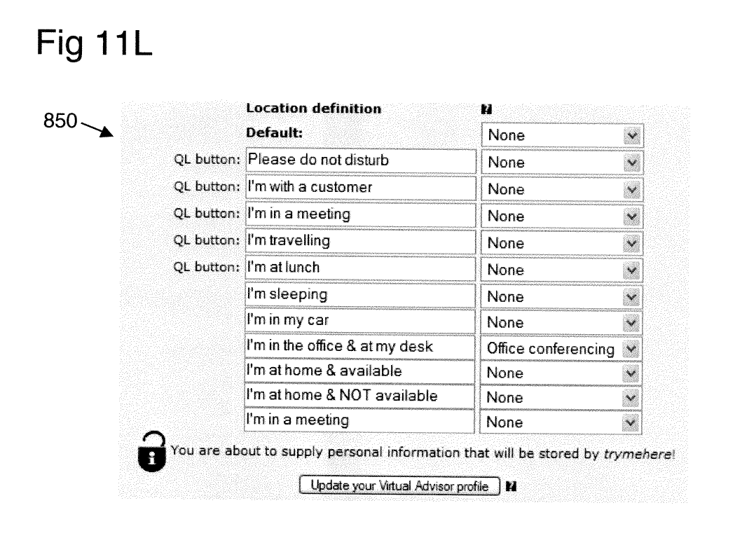

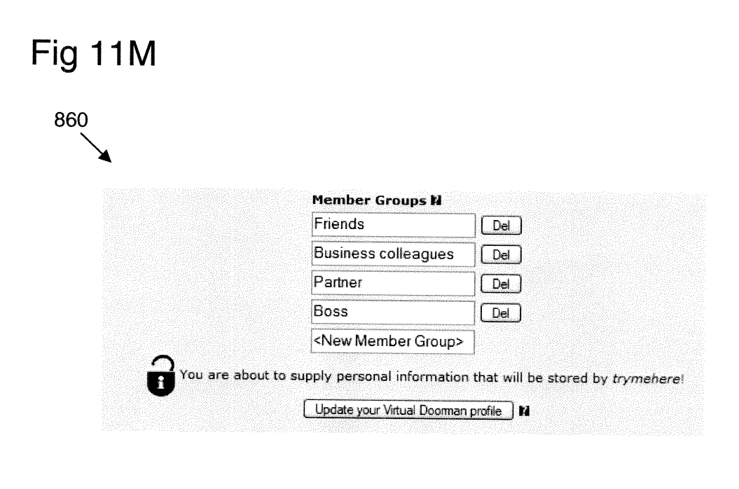

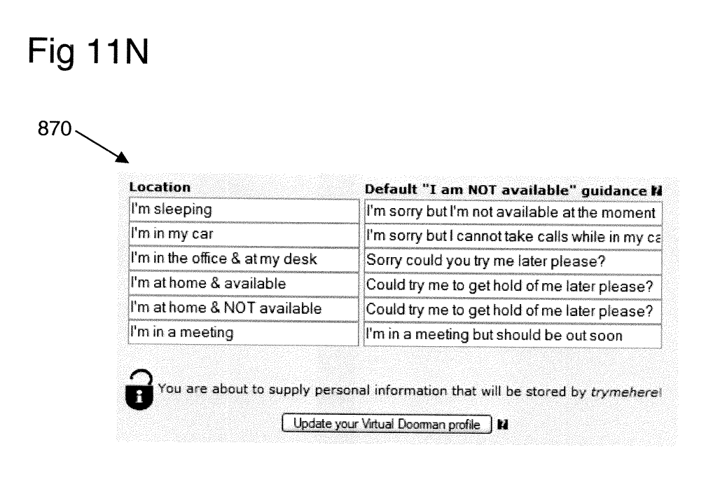

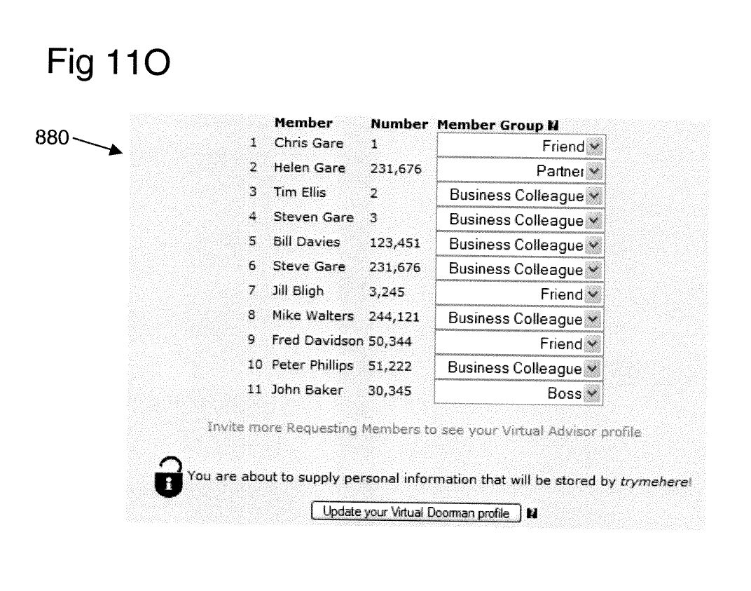

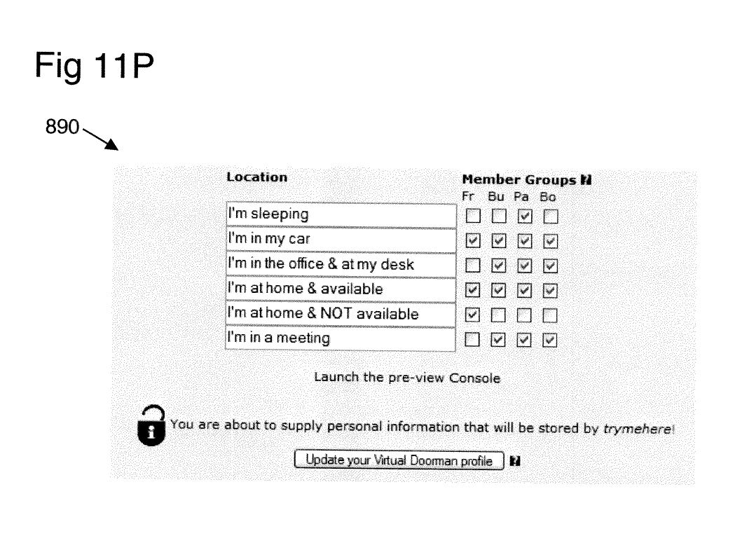

FIG. 11A shows a Member Information data entry page;

FIG. 11B shows a define personal communications services profile entry page;

FIG. 11C shows a define Location or Activity page;

FIG. 11D shows a define Location or Activity Groups page;

FIG. 11E illustrates how Locations or Activities are added to Location or Activity Groups.

FIG. 11F shows an attach alternate contacts to Locations or Activities page;

FIG. 11G shows an attach fixed telephones to Locations or Activities page;

FIG. 11H shows an attach mobile telephones to Locations or Activities page;

FIG. 11I shows an attach Internet VoIP to Locations or Activities page;

FIG. 11J shows an attach email services to Locations or Activities page;

FIG. 11K shows an attach Instant Messaging services to Locations or Activities page;

FIG. 11L shows an attach Other communications services to Locations or Activities page;

FIG. 11M shows a create User profile entry page;

FIG. 11N shows a Define Member Groups non-availability messages page.

FIG. 11O shows a Link Requesting Members to Member Groups page;

FIG. 11P shows a Link Member Groups with Locations or Activities page;

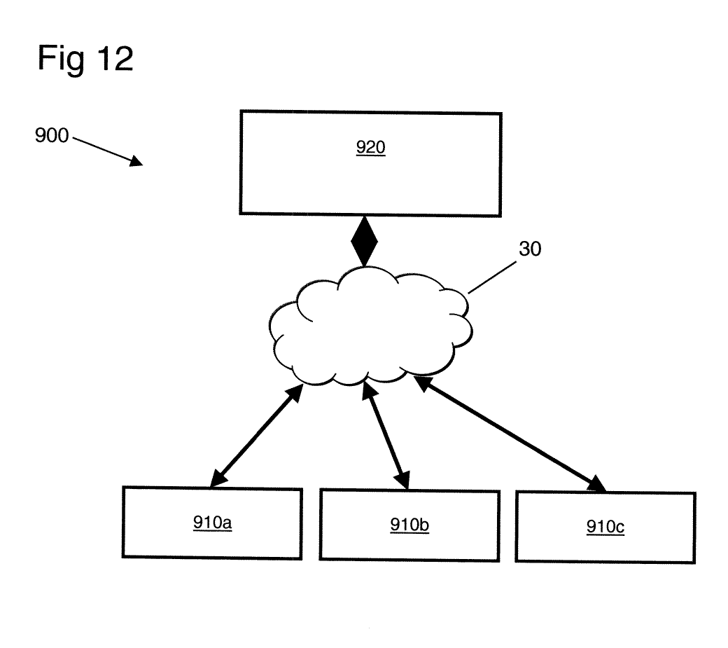

FIG. 12 illustrates the single update and retrieval of multiple broadband services live status flags.

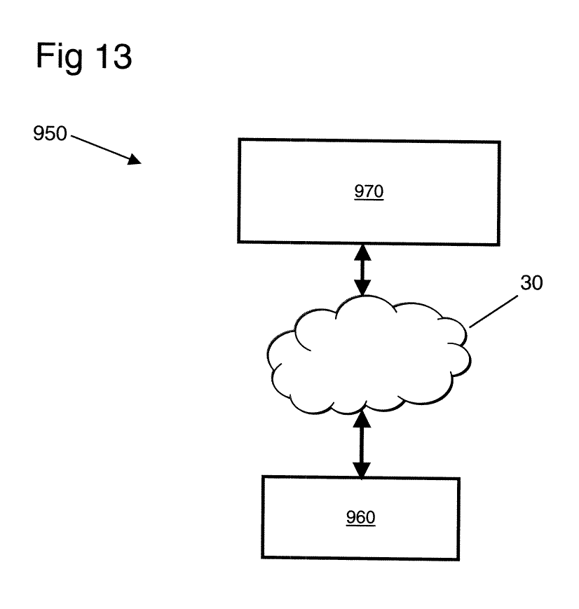

FIG. 13 illustrates automatic update of predefined calendar data.

FIG. 1A illustrates, as a first embodiment of the present invention, an on-line Internet or intranet service run on a public or private stand-alone basis. The system shown in simplified form consists of a centrally located web-server 10 and database 20 hosted in a secure third party facility that is connected via the Internet or a private intranet 30 to users 40. In real deployment there could be hundreds of thousands of concurrent users, but only three users are shown: user A 40a, user B 40b and user C 40c.

The term “standalone” is used in connection with this first embodiment since it stands alone in capability and is not a component of any third party service or software application made available to users. In practice, users pay a subscription to receive the service.

FIG. 1B illustrates, as a second embodiment of the present invention, a public or private ‘bolt-on’ capability to an existing Internet on-line service or enterprise software application. Again, the system shown in this simplified form consists of a centrally located web-server 10′ and database 20′ hosted in a secure third party facility that is connected via the Internet 30 to users 40.

The term “bolt-on capability” is used in connection with this second embodiment since it may be run as a component of a third party service or enterprise software application 45 made available to users. This third party service could be an existing on-line Internet service or enterprise software application such as a mobile telephone address book contact synchronisation service for any of a personal computer, PDA or smartphone, a business, personal or social networking community, a conferencing centre service, a personal identity management service, an instant messaging service, a chat or dating community, a gaming community, or some other calendar related service. These services could run by Internet-based stand-alone service companies or other communications companies such as a fixed-line or mobile telephone operator. In practice, the service as herein described could be licensed for use by the third party service provider or enterprise software vendor.

In either of the above system embodiments, the web-server 10, 10′ is built using standard Internet or intranet resilient server technology and is connected to the Internet 30, via a software or hardware firewall to prevent unwanted hacking of the private data held in the global database containing the personal information entered by the users of the service. The hardware and server-side software components are architected for appropriate scalability, resiliency and to an appropriate security level for use as a global Internet-based service.

The web-server 10, 10′ in one variant of these embodiments is publicly available to users 40 over the Internet 30 and is open to any Internet user to use and subscribe to as a public service. Consumers or business users working at home or away from the office would access the service directly using the Internet 30. Business users would access the service via their company's LAN or WAN or remotely connect to the service via the Internet using a proxy server and firewall to provide adequate security.

A further variant of these embodiments is run as a private service inside a company intranet domain where the only users are employees of that company. In this variant, the service web-server is installed on the company's LAN or WAN inside their firewall in the company's secure datacentre. The intranet service is made available as a remote service using the Internet as the access network for remote employees.

An example of how these embodiments of the present invention may be used will now be described in a situation where User A 40a is a Providing Member who wishes to make available in real-time the information provided by the current invention to user B 40b and user C 40c, the Requesting Members. User A has previously specifically authorized users B and C to see User A's information or has provided “Public Access” such that that all users are able to see the information. In this latter case, no individual user authorization is required. Users B and C, as Requesting Members, access the web-server and request Location or Activity information provided by user A. This Location or Activity information is then provided by the web-server to Users B and C. Of course, a Providing Member may also be Requesting Member and vice-versa, so User A may access the web-server and request to see Location or Activity information for User B. This information will be provided to User A if User B has authorised User A to see this information, either specifically or generally under “Public Access”.

FIG. 2 shows the client devices that may be used with the system of FIGS. 1A and 1B, although only the embodiment of FIG. 1A is illustrated in FIG. 2. There are four main types of client device that users could use: personal computers or laptops 50 running a web browser such as Internet Explorer™, Firefox™ or Opera™; Internet-enabled Personal Digital Assistants (PDAs) 60 and possibly including Bluetooth or Wi-Fi connectivity enabling a user to access the Internet or an intranet wirelessly when located in a hot spot; Internet or WAP-enabled mobile or cell telephones or “smart phones” 70; and other Internet-enabled devices (not shown) such as public Internet access booths, Internet-enabled fixed telephones, game consoles, Blackberry™ and similar “on-the-move” email devices, integrated home entertainment consoles, TVs and other future Internet-enabled devices that may be developed.

Users having these different client devices may use the service embodying the present invention in different ways. For example, a user using a PC or laptop 50 might launch a small pop-up window known as a “Console” and leave it there as a persistent window for ease of use throughout the course of their working day while at their desk. A PDA 60 user, however, would sign-in to the service and launch the Console for a single use before signing-out to preserve battery power or because they are on the move.

The “Console” is the main user interface for users using a personal computer 50, PDA 60 or smart mobile telephone 70 to access the service embodying the present invention. The Console could be delivered in the form of a standard HTML, XML or WAP based web page or could be created with client or server-based software such as Java™ or ActiveX™ or on a mobile telephone using J2ME™ or Qualcom BREW™. Users use the Console to request to see other user's Location or Activity and service information and to set their own Location or Activity status on a real time basis. At the end of the session, users sign-out and close the Console in the normal manner.

In the case of a mobile telephone with only a small screen and using WAP, the Console content could be limited to a set of QuickStatus buttons that are used to quickly set Location or Activity while on the move and a limited amount of Location or Activity information.

The information supplied in the Console could also be delivered to a mobile telephone in an SMS message by the service and a Providing Member could also set their Location or Activity by sending an SMS message thus not requiring the use of the Internet at all.

Further, the information supplied in the console could be accessed and delivered using a voice-based Interactive Voice Response (IVR) system with Providing Member guidance being read to a Requesting Member using voice synthesis software thus not requiring the use of the Internet at all.

FIG. 3A shows the global user relational database 20 which is used server-side to store Member Profiles entered by users of the service. The database holds multiple individual user records 80 that are standardized for each user and consist of elements of data such as names, Locations or Activities, available communications services, defined Member Groups, authorized users and the associations between Locations or Activities, authorized users, Member Groups and services. These records form individual Providing Member Profiles.

Users in the database 20 may be segmented into company groups to support closed company user-groups for use by companies when using the service in a private company environment. If required, a separate instantiation of the database is supported if security is deemed particularly important by any company. Segmentation by companies is important for managing company subscriptions and helping users identify a particular user when searching the global database.

If a company makes private use of embodiments of the present invention, then a completely separate user database could be supported for exclusive use by that company. For use as a ‘bolt-on’ service to an existing third party service or enterprise software application the database would be subsumed into that third party's existing user database. For world-wide use by large numbers of users, a distributed database with replicated data on three continents could be used to improve response times to local users.

FIG. 3B illustrates a Providing Member's Requesting Member Group 100. A “Providing Member” 110 is a user that is a subscriber to the service and wishes to use the service to publish in real time their location, their willingness or ability to communicate, the services they are able or willing to use at particular Locations or Activities and to personalise the presented information depending on the Member Group of a Requesting Member 120 requesting the information. The Providing Member 110 would by necessity have previously created a Member Profile.

The Providing Member can choose to allow all users of the service to see their Location or Activity and other information by providing public access to all Requesting Members. However, the preferred mode of operation would be that the Providing Member would “invite” specifically selected colleagues and friends to be able see their Location or Activity information. In this way, the system prevents anyone else from seeing the Providing Member's information other than invited and authorized users. These groups of linked users clustering around a Providing Member are called a Requesting Member Community. Every user of the service will have their own personal Requesting Member Community whose relationships will form a core part of their Member Profile held in the global database. Users can be a member of multiple Requesting Member Communities.

A user 110 can search the global database 20 at any time to discover whether a contact is already a user of the service. Search terms could include names, companies, email addresses or other information that specifically identifies an individual. The Providing Member can enter several variations of their name into the database to help improve the quality of the search by other users e.g. Dave Brown or David Brown. If the contact is found and therefore is already a user of the service, they can send an email invitation to the user to set up mutual or reciprocal privileges to see each other's Location or Activity information. If the required contact is not found in the database, the Providing Member can enter the contact's email address and have the service send an email to the contact inviting them to join the service. The email contains a link back to the service web site where the invited contact can accept or decline the invitation. If the contact accepts, they are taken to a subscription page where they will be able to become a Requesting Member by registering to use the service. The Providing Member who sent the invitation is provided with an invitation tracking page that is updated with the status of the invitation according to one of three different levels: (a) Outstanding (b) Accepted, and (c) Declined or other types of status such as Lapsed.

Once a Requesting Member community 100 has been built up by the Providing Member 110, they can choose to delete or remove a link with an individual member 120 of the Requesting Member Community any time they wish if they are abusing the information being provided. Similarly, a Providing Member can decide to delete their own Member Profile and Requesting Member Community at any time if they wish to stop using the service for whatever reason.

FIG. 4 is a Venn diagram illustrating a “Conditional Visibility Rule Engine” (CVRE) 130. A Providing Member's Profile in the global database contains their information profile and consists of four main groups of data other than the basic information required to subscribe to the service. These groups include: (a) the Providing Member's set of self-defined Location or Activity definitions 140 such as “I'm in the office” or “I'm working from the hot desk in Red Lion Square”. Locations or Activities are grouped into “Location or Activity Groups or schedules” and have start and end times and dates (in the case of temporary Locations or Activities groups or schedules) linked with them enabling the Providing Member to define Locations or Activities that are regular or routine, say every day of every week, and Locations or Activities that are temporary that will be used on an ad hoc basis such as “I'm in a meeting” or “I'm unavailable”; (b) the set of communication services available at a particular Location or Activity or the set of services that the Providing Member wishes to show as being available at particular Locations or Activities 150. These include fixed and mobile telephones, VoIP and Instant Messaging services, personal assistants or secretaries, conferencing services, faxes or pagers etc; (c) the Providing Member's set of self-defined Member Groups. These are preferably grouped broadly into personal, business or other and consist of any category that the Providing Member finds relevant to categorise or classify their colleagues and friends such as “Partner”, “Family”, “Friends”, “Classmates”, “Teachers”, “Co-workers”, “Boss”, “Project team members”, “Board members”, “Shareholders”, “Suppliers” or “Customers” etc; and (d) the Member Group used to categorise each Requesting Member that is a member of the Providing Member's Requesting Member Group 160 e.g. “John Davies” is placed in the “Co-workers” category. The intersection of the circles 170 in the Venn diagram 130 of FIG. 4 represents the information that is provided to a particular Requesting Member according to the Providing Member's preset rules that allows or disallows visibility to Requesting Members.

Simply stated, the CVRE 130, controlled by rules set by the Providing Member, determines the precise content of the information that a member of the Providing Member's Requesting Member Community sees when they request the current Location or Activity information of a Providing Member. Preferably, the CVRE operates by (a) determining the priority allocated to the Providing Member's current Location or Activity e.g. active QuickStatus Locations or Activities will override temporary activities, active temporary Locations or Activities will always override routine daily Locations or Activities; (b) determining the current local time and date of the Providing Member based on their current physical location's time-zone; (c) associating the available communication services as defined by the Providing Member as being available at their current location; (d) associating each member of a Providing Member's Requesting Member Community with a particular Member Group as defined by the Providing Member; and (e) dynamically comparing the name, Member Number, or associated Member Group of the member of the Providing Member's Requesting Member Community with a rule set defined by the Providing Member that determines when a particular Member Group is allowed to see the Providing Member's current Location or Activity and the service information linked with the current Location or Activity.

If the Requesting Member is allowed to see the Providing Member's current Location or Activity they can be shown the following information in the Console: (a) The local time of the current location and the country they are currently located in; (b) the associated communications services available at the current Location or Activity. Telephone numbers are translated in real-time and are presented in a format that allows a Requesting Member to click to dial in their country of location; and (c) default “availability” guidance messages linked to that current Location or Activity. A Providing Member can override this default guidance with a more relevant “flash guidance” if they so wish e.g. “Had to dash to a meeting”.

If the Requesting Member is not allowed to see the Providing Member's current Location or Activity they are shown the following information in the Console: (a) the local time of the current Location or Activity and the country they are in; (b) a default “non-availability” message associated with that defined current Location or Activity.

Preferably, a Providing Member can “pretend” to be a particular Requesting Member, select a time and date to preview the information that would be shown in the Console to that particular Requesting Member. This will enable them to preview how their information will be seen by the selected Requesting Member.

FIG. 5 is a simplified architectural block diagram based on standard web-server industry principles and technology. At the core of the system's architecture is a database 20 used to store Member Profiles server-side. This may be based on an open source database such as mySQL™ or a proprietary SQL database available from companies such as Sybase™, IBM™, Microsoft™ or Oracle™. The database 20 is connected to several logical data-management modules 200, preferably written in PHP™, whose principal function is to control the various processes required to inwardly manage the database and its interaction with externally facing processes such as Member Profile data entry and the Linking Member to member Group management process. The modules 200 include a Location or Activity Management module, a Link Management module, an Availability Service Management module, a User Authorisation Management module, and a Member Group Management module. The modules 200 focus on Location or Activity data, communication services that are linked to those Locations or Activities, Member Group management and Requesting Member Community management.

A page server and Conditional Visibility Rules Engine module 210 respond to requests from Requesting Members to see a Providing Member's information by applying the Conditional Visibility Rules to the underlying Location or Activity, Location or Activity times, dates and available communication services data and Member Group and dynamically constructing the Console page before sending it to the Requesting Member's client Console in an appropriate form for the client device being used.

A user session controller 220 manages and maintains the multiple individual Providing Member and Requesting Member sessions that may be open at any one time.

FIG. 6 illustrates a Providing Member's Member Profile data entry process 250. When a new Providing Member starts using the system the first activity they need to undertake is to create their Member Profile that contains all the information needed for them to make use of the service. A user only wishing to be a Requesting Member has no need to create a full Member Profile and just needs to register on the service by providing a preferred email address and password. The process as shown in FIG. 6 is truncated as it only shows a portion of the data that needs to be entered by a Providing Member. However, the process is repetitive such that the remainder of the process will be clear to a suitably skilled person.

The process starts at step 260 when a Providing Member wishes to create or update their Member Profile following their sign-in to the system. Following a standard sign-in process, the Providing Member clicks on a “Manage profile” tab on the service's home page (step 270) and goes to the first page of data entry (step 280). The Providing Member updates the information and then clicks the “Update the information” button (step 290) which tells the system to store the updated information in the database and to update the page being edited by the Providing Member on his client device.

Other data entry processes are shown in FIG. 6, illustrating the data the Providing Member is required to provide to create or update their Member Profile. The data includes: (a) basic user information including preferred email address and password; (b) the Providing Member's name variants stored in the database used for search purposes; (c) regular and temporary Locations or Activities and their free-text names such as “I'm in the office”, “I'm in a meeting”, “I'm at home”, “I'm in my car”, “I'm on a train”. Locations or Activities are assembled into ‘Location or Activity Groups or schedules’ that could be called “Monday to Friday”, “Tuesday”, “Weekend” or “Sunday”. The same Locations or Activities can be used multiple times in different Location or Activity Groups or schedules; (d) calendar information in the form of dates and times linked to each defined Location or Activity in a Location or Activity Group or schedule. Additional information which is not shown in FIG. 6 but is preferably entered by a Providing Member includes: (e) details of alternate contacts such as personal assistants, secretaries or managers that the Providing Member delegates responsibilities to while away from the office; (f) fixed telephones and their numbers; (g) mobile telephones and their numbers; (h) Internet communications services such as VoIP telephony services and their linked access numbers or aliases; (i) personal, business or other email addresses; and (j) Instant Messaging services and their associated aliases.

Further information entered into the Member Profile may include: (k) Internet services such as web conferencing services, IRC, faxes, TELEX, chat rooms and pagers; (l) Member Groups and their names; (m) information for placing Requesting Members held in the Providing Member's Requesting Member Community with defined Member Groups; and (n) information for associating Member Groups with Locations or Activities. More detail about these information groups is provided below.

FIGS. 7A and 7B illustrate a Providing Member's invitation and linking process. An on-going task for a Providing Member is to invite their contacts in the form of friends, family and work colleagues to join their Requesting Member Community. As shown in FIG. 7A, a Providing Member who wishes to invite a contact to join their Requesting Member Community launches the service (step 300) and enters the name or email address of the contact into a text search box and presses a “Search” button. The global Member database is then searched (step 310) to see if the user is an existing user (step 320).

If the contact is already a Member, the system posts a flag on the invited Requesting Member's Console informing them that they have been invited to see the Providing Member's information (step 330). The flag includes a hyperlink that the contact can click on (step 335) to be taken to a page on the service web site (step 340) which contains “Accept” and “Decline” buttons. Preferably, an email including a similar hyperlink is also sent to the contact (step 350).

If the contact is not already a user of the service, the Providing Member will be invited to enter the email address of the contact. If the Providing Member knows the email address and enters it into the system an email invitation containing a hyperlink to the same page on the service web site is sent to the contact (step 360). The secure web page preferably encourages the contact to find out some of the benefits of the service and includes “Accept” and “Decline” buttons.

If an invited contact follows a hyperlink in the email (step 370), their default browser is launched on their client device and takes them to the dedicated services invitation page (step 380). An existing user can then accept or decline the invitation and a non-user can find out about the service before deciding whether they will accept or decline the invitation (step 390). If the Accept button is clicked one or more actions may result in steps 400 and 410: (a) if the invitee is not an existing Member the system double checks that the invitee is not a duplicate; (b) the user is added to the Providing Member's Requesting Member Community. The Providing Member is added to the Requesting Member's Requesting Member Community in a mutual way; (c) the names of the additional Requesting Member are added to both party's invite tracker records and the invite status changes from “Outstanding” to “Accepted” on the Manage Member pages; (d) a confirmation email is sent to the new Requesting Member and the Providing Member who sent the invitation.

If the Decline button is pressed then the Providing Member's invite tracker updates the invite status updated from “Outstanding” to “Declined” (step 420) on the Manage Member pages. A confirmation email may be sent to the Providing Member. The Providing Member can then email the contact that has declined if they so wish.

FIG. 8 shows a simplified user availability request and Conditional Visibility Engine process. A Requesting Member can at any time request to see the current or active Location or Activity and associated information of a Providing Member which will be presented in real time by launching the client Console and signing in (step 500). The Requesting Member selects the name of the Providing Member whose Location or Activity they wish to see, preferably from a drop-down multiple-selection box, and presses a “Request” button. The server-side system then initiates a new user session and a new instance of the Conditional Visibility Engine process whose outcome will be a dynamically created page posted back to the Requesting Member's Console on whatever client they are using.

The first step (step 510) in the Conditional Visibility Engine process is for the system to look up the Requesting Member's name in the Providing Member's database and see what Member Group the Requesting Member has been assigned by the Providing Member. The Providing Member's current Location or Activity is also ascertained. If the Requesting Member is not allowed to see the Providing Member's service information at their current Location or Activity a “non-availability” guidance message created by the Providing Member is sent to the Requesting Member (step 520).

If the Requesting Member is allowed to see the Providing Member's service information at the Providing Member's current daily routine or temporary Location or Activity or QuickStatus information then the system looks up any associated start and end times or start and end dates and compares them to the local time of the Providing Member at that daily routine or temporary Location or Activity (step 530). If there is no Location or Activity defined for the current local time, even though the Providing Member should have defined a Location or Activity for all times of the day from 00:00 to 23:59, then the set of services linked with the “Default” Location or Activity are presented to the Requesting Member (step 540).

If there is a daily routine or temporary Location or Activity defined for the current local time, the system checks (step 550) whether a “QuickStatus” override Location or Activity has been set by the Providing Member by use of the QuickStatus button on the Console. If this is the case then the service information and availability guidance message for this QuickStatus Location or Activity is used instead of the daily routine or temporary Location or Activity service information, as determined in step 560.

The Location or Activity and service availability page is then dynamically created and sent to the Requesting Member's Console (step 570). The Conditional Visibility Engine's activities and process instance close at this point for that particular Requesting Member session.

FIG. 9 shows a simplified “Set QuickStatus” Location or Activity and Preview Status Process. The Providing Member should define a sufficient set of regular Location or Activity with associated start and end times that can be assembled into a routine Location or Activity Group or schedule to cover a 24 hour day. The Providing Member can also define any number of temporary Locations or Activities with a start and stop date that would override daily routine Locations or Activities when enabled. It is also possible for a Providing Member for set up a number of override Locations or Activities that can be set from the client device's Console simply pressing a “QuickStatus” button. These Locations or Activities could be “I'm in a meeting” or “Do not disturb”, for example.

When a Providing Member wants to set a QuickStatus Location or Activity using a QuickStatus button they launch the Console (step 600) and sign-in to the service. On a mobile telephone this may necessitate the use of a PIN code rather than the preferred email address. They then select the QuickStatus Location or Activity they wish to use and preferably select the length of time the QuickStatus Location or Activity should remain valid and click the Submit button on the client Console (step 610). The server-side system will then override the current daily routine or temporary Location or Activity Group or schedule and set the Location or Activity to the QuickStatus Location or Activity selected by the Providing Member (step 620). The QuickStatus Location or Activity override with its linked Location or Activity and communications services will remain in place until the Providing Member sets the QuickStatus status to “None” on the client Console or the set duration time entered runs out. At this point the relevant current daily routine or temporary Location or Activity Group or schedule will reassert itself.

The Providing Member can then choose whether or not to preview their current Location or Activity at step 630. If the Providing Member decides not to preview their location, the process ends at step 640. If the Providing Member decides that they do wish to preview their current location, they select the preview tab on the Console (step 650) which launches a Location or Activity preview page on their client device (step 660). They then select a proxy Requesting Member and click a submit button (step 670) and the Console switches to a Requesting Member Location or Activity page and is updated to show the preview (step 680). This functionality will be described in more detail below.

FIG. 10A shows a Requesting Member Console page 700 that can be used on a PC, PDA or smartphone. The console can also be displayed in a simplified form on an Internet-enabled mobile or cell phone using a WAP service. The Console is dynamically generated by the server-side system and shows the current Location or Activity information of a Providing Member selected by the Requesting Member to the extent that the Requesting Member is authorised to see such information. The page may provide any of a number of different elements, including: a logo for the service provider or licensee; the Requesting Member's name, their membership number and a sign-in/sign-out hyperlink; a “You have invites” message, if other Users have requested that they wish to see the Requesting Member's Location or Activity information.

Also provided are four tabs enabling the Requesting Member to select a Providing Member Location or Activity information page, a Group Location or Activity page, a Set QuickStatus page and a Preview page. Below these four tabs Providing Member Location or Activity information page is a drop-down menu where a Requesting Member can select a Providing Member from their Requesting Member Community for whom they wish to see their current Location or Activity information. The Console provides the selected Providing Member's local time, the country they are currently located in, their availability guidance, their available communication services and other information supplied by the Providing Member as well as the default Location or Activity and Location or Activity message as drafted by the Providing Member. The Console may also include a “Refresh” button and a “sign out” button.

It is also possible to display a small “eye” icon that flashes for a pre-determined time following a request from a Requesting Member to provide positive feedback to the Providing Member that their Requesting Member community are using the service.

FIG. 10B shows a Providing Member Set QuickStatus page 710. The Set QuickStatus page on the Console is similar to the Requesting Member visibility page except that the Location or Activity information is replaced by a set of QuickStatus option buttons enabling the Providing Member to select an override QuickStatus Location or Activity. The Providing Member should have previously defined a set of Locations or Activities with associated start and end times to cover a 24 hour day and any number of temporary Locations or Activities that would override regular Locations or Activities if they have conflicting times defined. By selecting one of the QuickStatus option buttons and clicking on the “Set QuickStatus” button, it is possible for a Providing Member to select a QuickStatus Location or Activity to override any of the previously set Daily Routine or Temporary Locations or Activities for a pre-selected period of time.

FIG. 10C shows a Providing Member Preview Console page 720. The Preview page is similar to the Requesting Member visibility and the Set Location or Activity pages except that the Location or Activity information is replaced by a drop-down menu where the Providing Member selects a Requesting Member that they wish to ‘impersonate’ to preview how their current Location or Activity information would be presented to that particular Requesting Member. The Requesting Member is selected and the “Preview” button is pressed to initiate the request. The server-side system takes the command and switches the Console back to the Requesting Member page in the Console to show the information that would normally be shown to the selected Requesting Member.

FIG. 10D shows a Requesting Member Group Console page 730 which can be instantiated from the Console by selecting the “Group” link. There is often the need to track down several Providing Members at the same time, for example, when attempting to locate several delinquent participants in conference. By opening the Group Request page a Requesting Member is able to select several Providing Members at the same time. When the Update button is pressed a pop-up window is presented on the personal computer screen that shows the information for all of the Providing Members at the same time. The Console will also include a refresh button to retrieve updated information for each of the selected Providing Members at one time.

FIG. 11A shows a Member Profile data entry page 740. This is the first page of a number of pages that a Providing Member uses to create their own Member Profile. A Providing Member can add or update a preferred email address that will be used by the service to communicate with the Providing Member.

Other information on this page may also include their sign-in password and a PIN code for WAP-based mobile telephone access if required, several variants of their first and second names e.g. “Dave Jones” or “David Jones”, their company, their home country chosen from a pull down menu or, in a country with multiple time-zones their nearest city that will define their time-zone. Users also select their most commonly used “Preferred or Away Countries” so the number of country choices is reduced in subsequent menus to simplify use and speed up the performance of the system. Further information includes the preferred time and date formats preferred by the user.

A “Public” check box is included and the a Providing Member would use this check box to allow Public Access to their information if they are comfortable with letting any user of the service see their Location or Activity rather just pre-authorised Requesting Members. The use of this option means that a Providing Member has no need to invite other users to join their Requesting Member Community. Providing Members that have allowed Public Access will be marked as such in a Requesting Member's Manage Members page. Also, if a Requesting Member is aware that a particular Providing Member has allowed Public Access to their Location or Activity information they can just type the name into the request page on the Console even though they may not be a member of their own Requesting Member Community. The Providing Member can enter the names of all the organisations they work with which can then be later linked with the appropriate Locations or Activities. If this field is left blank then it will not be displayed on the Console when their Location or Activity information is presented to Requesting Members.

FIG. 11B shows a Define Personal Communications Services page 750. A Providing Member uses this page to enter the various communications services they could use at any or all the Locations or Activities they have defined. This would include alternate contacts such as personal assistants, fixed and mobile telephones, faxes, emails, VoIP, Instant Messaging, web conferencing Internet services or other services. Providing Members can add multiple individual services as they wish by clicking the “Add” button.

A Providing Member can temporarily disable a particular service at any time by un-checking an “enable” check box associated with that service. Individual services can be deleted by clicking the delete button.

Once the data has been entered or modified the Providing Member presses an “Update” button to enter the data into their Member Profile.

An advantage of embodiments of the present invention is that different email addresses (or any other type of communication service information) may be provided for each Location or Activity, thereby making it possible for a Providing Member to provide one email address for personal use and another email address for work use. Further, a Providing Member can provide different aliases for work and personal use with any VoIP or Instant Messaging service they may use. A Providing Member who works with several organisations would be able to link a different email address to each organisation Location or Activity, for example.

FIG. 11C shows a Define Locations or Activities page 760. A Providing Member can create or update unique Locations or Activities at any time by carrying out one or more of the following steps: (a) selecting whether a particular QuickStatus Location or Activity definition is used by the service or not by enabling or disabling it. A Providing Member can activate a QuickStatus Location or Activity at any time by clicking the appropriate button on the Providing Member Set Status Console of FIG. 10B; (b) describing a Location or Activity in a free text field; (c) defining a default “availability” message for a Location or Activity that would be presented to a Requesting Member; and (d) adding, deleting or redefining Locations or Activities as needed. Once the data has been entered the Providing Members presses an “Update” button to enter the data into the system.

These unique Locations or Activities can then be assembled into “Location or Activity Groups or schedules” by a Providing Member on the Location or Activity Group page 770 shown in FIG. 11D.

FIG. 11D shows a Define Locations or Activities Groups or schedules page 770. Following the creation of a number of unique Locations or Activities, the Providing Member assembles these into required Location or Activity Groups or schedules. There are two types of Location or Activity Group or schedule. The first type of group is known as a Routine or Daily Location or Activity Group or schedule. If a Providing Member is regularly at or undertakes the same set of Locations or Activities on the same day or days every week then the days that apply to a Location or Activity Group or schedule can be selected by checking appropriate boxes on the page. For example, if every week day of the week is the same then Location or Activity Groups or schedules called “Monday to Friday” and “Weekend” can be created. If Monday is different to the rest of the week then two Location or Activity Groups or schedules can be created, “Monday” and “Tuesday to Friday”. The limit is a Location or Activity Group or schedule for each day of the week. If a Location or Activity called “I'm in the office” is used in Location or Activity Groups or schedules it is possible to quickly to create an “I'm in a meeting” Location or Activity that can be used to override the “I'm in the office” location.

(b) The second type of Location or Activity Group or schedule is called a temporary Location or Activity Group or schedule for example “I'm in New York”, “I'm visiting Hong Kong” or “I'm at Hampton's office in Manchester”. The Providing Member can define multiple temporary Location or Activity Groups or schedules that can be made active for a specified period by specifying the start day and the end day by pressing the “date” button associated with each temporary Location or Activity Group or schedule. A pop-up calendar is presented to the User so that they are able to select start, end dates, arrival time and leave time. The data will be parsed to check that the end date follows the start date.

To complete the Location or Activity Group or schedule page each Location or Activity Group or schedule needs to be populated with Locations or Activities defined using the Define Locations or Activities page 760 shown in FIG. 11C. This is achieved by pressing the “time” button on each regular or temporary Location or Activity Group or schedule as shown in FIG. 11D.

Location or Activity Groups or schedules can be added, deleted or duplicated complete with their associated Location or Activity definitions at any time. Once the data has been entered, the User presses an “Update” button to enter the data into the system.

FIG. 11E illustrates an Add Locations or Activities to Location or Activity Groups or schedules page 780, which shows how Locations or Activities are added to Location or Activity Groups or schedules. After a Providing Member has defined a number of Location or Activity Groups or schedules then they are able to assign previously defined Locations or Activities to Location or Activity Groups or schedules using a calendar-like pop-up window interface.

This is achieved by a Providing Member selecting a time range that they would like to link to a particular Location or Activity such as “I'm in the office” to start at 09:00 and last to 17:00. This is achieved by entering the required start and end times in the menu and selecting the required Location or Activity from the drop down menu that includes all the previously defined Locations or Activities. The information will be parsed to check that the end time is greater than the start time.

The Location or Activity and its associated start and end times are then entered into the database by pressing the “Enter information” button. Locations or Activities can be deleted by pressing the “Delete location” button.

The Providing Member should ensure that there are sufficient Locations or Activities defined with start and end time to fully cover a full day as these will be presented automatically by the system unless overruled by a temporary or QuickStatus Location or Activity. If there is a gap, then the system will select a default Location or Activity and use its attached services when a request is received from a Requesting Member.

The Add Locations or Activities to Location or Activity Group or schedule page consists of two columns. The 00:00 to 23:59 set of Locations or Activities are entered in the left-hand column as described above but it is also possible to enter over-riding Locations or Activities in the right-hand column that if present will override the Locations or Activities in the left-hand column. For example, a Location or Activity as defined in the left-hand column could be defined as “I'm at my desk” and lasting from 13:00 to 17:30 hours. While an over-ride Location or Activity such as “I'm in a meeting” from 15:00 to 16:00 could be defined and placed in the right-hand column. During the hour of 15:00 to 16:00 the “I'm in a meeting” Location or Activity will take precedence. A benefit of this approach is that Locations or Activities in the right-hand column can be changed at will without disturbing underlying regular Locations or Activities. Optionally, Locations or Activities in the right-hand column may be synchronised with a Members calendar application such as Outlook™ using an Add-in application.

FIG. 11F shows an attach Alternate Contacts such as a Personal Assistant to a Location or Activity page 790. Typically this page will only be used for business related Locations or Activities. A Providing Member can attach a personal assistant, secretary, a work group associate or perhaps a delegated manager (when on holiday) to any Location or Activity. A personal assistant or other linked contact is therefore a “service” available at any defined location. The personal assistant does not have to be a user of the service for a Providing Member to make their details visible to Requesting Members.

A Providing Member can add multiple alternate contacts to a particular Location or Activity by pressing the “Add” button or delete an extra personal assistant by pressing the “Delete” button.

Once the data has been entered, the Providing Member presses an “Update” button to enter the data into the system.

FIG. 11G shows an attach Fixed Telephones to a Location or Activity page 800. Using this page a Providing Member can attach a fixed telephone to appropriate Locations or Activities. For example, a fixed telephone in the Providing Member's home can be attached to all home-related Locations or Activities or a fixed telephone in a hotel could be attached to a temporary Location or Activity while travelling. A Providing Member can add multiple fixed telephones to a particular Location or Activity by pressing the “Add” button or delete an additional Fixed Telephone Service by pressing the “Delete” button.

Once the data has been entered, the Providing Member presses an “Update” button to enter the data into the system.

FIG. 11H shows an attach Mobile Telephones to Locations or Activities page 810. This page is similar to and operates in virtually the same manner as the Attach Fixed Telephones to Locations or Activities page 800 of FIG. 11G, but is used to attach mobile phones to Locations or Activities. A single Location or Activity may have both fixed telephone numbers and mobile phone numbers linked to it, and may have several of each some of which may be defined as personal numbers, others as business numbers. A Providing Member can add multiple mobile telephones to a particular Location or Activity by pressing the “Add” button or delete an additional Mobile Telephone Service by pressing the “Delete” button.

Once the data has been entered, the Providing Member presses an “Update” button to enter the data into the system.

FIG. 11I shows an attach Internet VoIP services to Locations or Activities page 820. Using this page, a Providing Member can attach Internet VoIP services to Locations or Activities in a similar manner as to the other services attachment pages. One difference with this page is that it preferably also gives the user the option of entering a link to a “Knowledge Base” for the service that will be seen by Requesting Members. The Knowledge Base contains more detail about a particular Service Provider and preferably includes links to an informational web page owned by the Service Provider. Alternatively, the link entered by the Providing Member may go directly to the Service Provider web page if a Knowledge Base page is unavailable or not provided by a system or service embodying the present invention.

A Providing Member can add multiple Internet VoIP services to a particular Location or Activity by pressing an “Add” button or delete an additional VoIP service by pressing a “Delete” button. This capability enables the Providing Member to assign a personal alias to a personal VoP service and a business alias to a business VoIP service and publish the former only to friends and the latter only to work colleagues.

Once the data has been entered, the Providing Member presses an “Update” button to enter the data into the system.

FIG. 11J shows an attach Email services to Locations or Activities page 830. Using this page a Providing Member can attach appropriate email addresses to particular Locations or Activities. A Providing Member can add multiple email services to a particular Location or Activity by pressing an “Add” button or delete an extra personal assistant by pressing the “Delete” button. This capability enables the Providing Member to assign personal Email services to home related Locations or Activities and business Email Services to business related Locations or Activities and publish the former only to friends and the latter only to work colleagues.

FIG. 11K shows an attach Instant Messaging (IM) Services to Locations or Activities page 840. Here, a Providing Member can attach Instant Messaging services to Locations or Activities. As with the attach VoIP Services page, this page preferably also gives the User the option of entering a link to a “Knowledge Base” for the service that will be seen by Requesting Members. The Knowledge Base contains more detail about a particular Service Provider and preferably includes links to a informational web page owned by the Service Provider. Alternatively, the link entered by the Providing Member may go directly to the Service Provider web page if a Knowledge Base page is unavailable or not provided by a system or service embodying the present invention.

A Providing Member can add multiple Internet Instant Messaging services to a particular Location or Activity by pressing the “Add” button or delete an additional Instant Messaging service by pressing the “Delete” button. This capability enables the Providing Member to assign a personal alias to a personal IM service and a business alias to a business Instant Messaging service and publish the former to personal friends and the latter to work colleagues.

Once the data has been entered, the Providing Member presses an “Update” button to enter the data into the system.

FIG. 11L shows an attach Other Communications Services to Locations or Activities page 850. Here, a Providing Member can attach other services to each Location or Activity such as numbers for fax machines, pagers, TELEX machines or video conference equipment. Other services could also include Internet based services such as IRC, “meet-me” rooms, virtual reality Internet sites or web conference services. Once the data has been entered, the Providing Member presses an “Update” button to enter the data into the system.

FIG. 11M shows a create Member Groups page 860. A Providing Member may define a set of Member Groups selecting appropriate names and terminology for the Member Group such as “Friends”, “Family”, “Co-workers”, “Boss”, etc; A Providing Member is able to define as many, or as few, as they require mirroring the complexity of their personal and business lives.

FIG. 11N shows a Define Member Group “non-availability” guidance messages page 870. This information could be combined with the “availability” guidance messages as shown in diagram 11C. A Providing Member uses this page to create default messages that Requesting Members in a particular category will see if they are not permitted to see the Location or Activity information for a particular location, such as “Sorry, but I'm at work at the moment” for a “Friends” related Location or Activity or “Please call me tomorrow morning” for a “Work colleagues” related location.

Once a guidance message has been entered or updated, the Providing Member presses an “Update” button to enter the new data into the system.

FIG. 11O shows a Requesting Member to Member Groups page 880. Using this page, a Providing Member can link a Member Group defined on the Create Member Groups page 860 of FIG. 11M with a Requesting Member in their Requesting Member Community. A Member Group may contain as many Requesting Members as they wish or a minimum of one Requesting member e.g. spouse or boss. Members of the Providing Member's Requesting Member Community are listed and the Providing Member can select the appropriate Member Group by selecting it from a pull-down list.

Once the data has been entered, the Providing Member presses an “Update” button to enter the data into the system.

FIG. 11P shows a Link Member Groups with Locations or Activities page 890. The Providing Member uses this page to link Member Groups to specific Locations or Activities in order to define which Requesting Members (according to the Member Group assigned by the Providing Member using the Link Requesting Members to Member Groups page 880 shown in FIG. 11O) are permitted to see Location or Activity information with each Location or Activity. The links are set up by checking the desired check-boxes in a form consisting of rows of Member Group and columns of Locations or Activities.

Once the data has been entered, the Providing Member presses an “Update” button to enter the data into the system.

FIG. 12 illustrates a system for single update and retrieval of multiple broadband services live status flags 900. A system embodying the present invention retrieves and pushes presence status information from Internet communications services 910. It is quite common for Internet Service Providers, such as VoIP service providers or IM service providers, to provide a live status flag indicating whether a particular user is on-line (or live). However, if an individual uses several of the available services it may be inconvenient or impossible for them to retrieve or update the status flag at each Service Provider individually. A system embodying the present invention enables a Providing Member to retrieve and update all of the status flags for services that they use by simply entering their status into the Console 920. Requesting Members would then be able use their Console to see the live status flags for a Providing Member.

This capability would be achieved by using a Service Provider's open API (used by many Service Providers) to inspect and set status flags and to integrate them with the Location or Activity information held by the system embodying the present invention.

FIG. 13 illustrates a system for automatically updating predefined calendar data 950. A system embodying the present invention may be automatically updated from a Providing Member's calendar 960 such as Microsoft Outlook™. A Providing Member will may have a calendar application on their client device to store an agenda of daily commitments or appointments. To prevent a Providing Member from having to enter fine granularity Location or Activity information such as meetings twice (into two different systems) a system embodying the present invention may automatically read the contents of a calendar to pre-populate a set of Locations or Activities in the Providing Member's Profile 970. A system embodying the present invention may also update the calendar application 960 on the User's client device based on Location or Activity information entered by the User in the Member Profile 970, if desired.

A system embodying the present invention may also send email or SMS to particular Requesting Members or to Requesting Members in a particular Member Group if a Providing Member's Location or Activity or availability changes. A system embodying the present invention may also automatically connect a Requesting Member to a Providing Member if the Requesting Member selects an appropriate communication service for a Providing Member's current location. This may be done by automatically dialling a fixed or mobile telephone number if a Requesting Member is using a PDA, smartphone or mobile telephone to view the Location or Activity information. Alternatively, if the Requesting Member is using a PC or other suitable equipped client device, a window could be opened to the appropriate VoIP or Instant Messaging (IM) service.

The preceding detailed description of the present invention uses a number of terms that may be unfamiliar and the following two glossaries may help in understanding the present invention. However, these glossaries are provided only as a guide and should not be seen as placing any limitation on the present invention or the claims.

### INDUSTRY TERM GLOSSARY

Address book synchronisation: Most business people have a large address book and as people often change jobs it is difficult to keep them up to date and relevant. Several companies offer services to keep address books up to date automatically by updating your entry in other users address books automatically over the Internet when you change your data. Such companies include Plaxo™, Midentity™ and Good Contacts™.

Hot desk: “Hot-desking” often goes hand-in-hand with telecommuting and mobile working, enabling people to work in a wide range of Locations or Activities. The idea is that employees or contractors share a single desk and a common fixed line telephone. The number of available desks is equal to the maximum number of staff likely to be in at one time, which is usually far less than the total number of staff.

VoIP: A technology for transmitting ordinary telephone calls over the Internet using packet-linked routes. Also called IP telephony. Companies such as Skype™ and Vonage™ offer ‘free’ consumer services to users of their service. If users go “off service” they are charged PSTN rates.

Wi-Fi: Wi-Fi is short for “wireless fidelity” an enable wireless connection to networks such as the Internet. Wi-Fi ‘hot spots’ a re to be found in Locations or Activities such as airports, railway station, coffee shops and hotels.

### PRESENT INVENTION GLOSSARY

Conditional Visibility Engine: Software that looks at the data in a Providing Member's Member Profile, such as the Member Group of a Requesting Member, before deciding what Location or Activity information to present to that Requesting Member.

Console: The Console is a pop-up window that a User uses to access a service embodying the present invention.

Location or Activity: Locations or Activities are short unique descriptions of the locations used by a Providing Member, such as “I'm in the office” or “I'm working at home” or “I'm in a meeting”. The terms “location”, “activity” and “location and activity” may be used interchangeably, throughout the description and claims such that location should not be construed as merely being a place but may also mean an activity performed by a Providing Member. Locations or Activities are grouped together to form Location or Activity Groups or schedules that cover an individual day or a group of days. Locations or Activities can also be “events” such as a conferencing session, a business meeting, or a particular session at a conference. A Providing Member's current Location or Activity is presented following a Requesting Member's request in real time according to the time of day.

Providing Member: The “Providing Member” is the term used for a user of the service that wishes to “publish” their Location or Activity and linked communications service information to other users called “Requesting Members”. A Providing Member builds up a group of other users who are authorized to see their Location or Activity information and be a member of the Providing Member's “Requesting Member Community”. A Providing Member may be required to pay an annual “Providing subscription”.

Requesting Member: A Requesting Member is a member of a Providing Member's Requesting Member Community” and is authorized to see the Providing Member's Location or Activity and other associated information. A Requesting Member is also able to see the Location or Activity and the Location or Activity information of all Providing Members that have provided Open Access to their Location or Activity information. A Requesting Member may be required to pay an annual “Requesting subscription”.

Requesting Member Community: This is a group of Requesting Members who have been given the authorization by a Providing Member to see their Location or Activity information.

Member Group: A Member Group is defined by a Providing Member and is a group of Requesting Members that have a commonalty e.g. “Friends” or “co-workers”. Some Member Groups may contain only one member such as “Partner” or “Boss”.

Member Profile: The Member Profile is the data held in a database for a Providing Member which defines that Providing Member's Location or Activity information, Requesting Member Community, Member Groups and so forth.

1. A method of providing location information for a first individual to a second individual comprising the steps of:
storing location information relating to a plurality of locations of the first individual, each location being associated with a time period for which the respective location is an active location and a user-defined description of the respective location;
receiving, at a time, a request from the second individual for location information for the first individual; and
providing to the second individual location information for the first individual for the location that is the active location at the time of the request.

2. The method of claim 1 wherein the location information includes a default location used as an active location at a time when no other location is an active location.

3. The method of claim 1 wherein the location information for a location includes at least one communication service available at the location.

4. The method of claim 3 wherein the at least one communication service includes any of: a physical address, a fixed telephone, a facsimile, a mobile telephone, a voice over IP telephony service, an email address, an instant messaging service, a telephone or video conferencing service, details of a Wi-Fi hotspot, a pager, a personal assistant and a delegated manager.

5. The method of claim 3 wherein the location information further identifies a network location that describes a communication service.

6. The method of claim 1 wherein the first individual is a user of a service for providing location information, the method further comprising the step of:
sending an invitation from the first individual to the second individual inviting the second individual to become a member of the service.

7. The method of claim 1 further comprising the step of the first individual pre-authorising the second individual to see location information for at least one location of the plurality of locations of the first individual.

8. The method of claim 7 wherein the location information includes default location information that is provided to a second individual if the second individual is not authorised to see the location information for the active location.

9. The method of claim 1 further comprising the steps of:
the first individual assigning the second individual to one of a plurality of categories; and
the first individual associating the one category of the plurality of categories with a location such that the second individual that is assigned to that category is pre-authorised to see the location information for the associated location.

10. The method of claim 1 further comprising the step of:
the first individual previewing the location information that would be provided to the second individual.

11. The method of claim 1 further comprising the steps of:
assigning a priority level to each location; and
if more than one location is an active location providing to the second individual location information for the active location that has the highest priority.

12. The method of claim 1 wherein the step of storing location information comprises at least one of:
the first individual entering location information using a calendar-like interface; and
automatically extracting data from an electronic calendar of the first individual.

13. The method of claim 1 wherein the step of storing location information comprises receiving account status information of the first individual from one or more Internet communications service providers.

14. The method of claim 1 wherein the location information further comprises an override location, the method further comprising the step of:
the first individual setting the override location as the active location with a single action.

15. An apparatus for providing location information for an individual to a client device comprising:
a database for storing location information relating to a plurality of locations of the first individual, each location being associated with a time period for which the respective location is an active location and a user-defined description of the respective location; and
a processor in communication with the database, the processor being programmed to:
receive, at a time, a request from the client device for location information for the first individual;
retrieve, from the database, location information for the first individual for the location that is the active location at the time of the request; and
provide the retrieved location information to the client device.

16. The apparatus of claim 15 wherein the processor is connected to a network and wherein the request from the client device is received over the network.

17. The apparatus of claim 15 wherein the client device is any of: a personal computer, a personal digital assistant, a mobile telephone, a games console, a fixed-line telephone, and a network-enabled home entertainment system.

18. The apparatus of claim 15 wherein the processor is programmed to provide the retrieved location information to the client device formatted as any of: at least one web page, at least one email and at least one SMS message.

19. The apparatus of claim 15 wherein the processor is further programmed to receive, from a client device of the individual, location information for storing in the database.

20. A method of retrieving location related information about a first user by a second user comprising the steps of:
receiving from the second user identification information identifying the first user;
determining a current local time for the first user;
retrieving from a database details of a location including contact information for the first user for the current local time; and
displaying the retrieved details to the second user.

21. The method of claim 1, wherein the information provided to the second individual is a telephone number for the first individual and the method further comprises the step of formatting the telephone number into a form that is to be dialled by the second individual depending upon the respective locations of the first and second individuals.

22. The method of claim 22, wherein the formatting step includes the addition or deletion of area or country codes.

23. A method of providing location information for a first individual to a second individual comprising the steps of:
storing location information relating to a plurality of locations of the first individual;
receiving a request from the second individual for the local time of the first individual located at one of the plurality of locations;
calculating from the location information the local time for the first individual; and
providing to the second individual the local time of the first individual.
